(19) United States
(12) Patent Application Publication
(10) Pub. No.: US 2026/0320141 A1
(43) Pub. Date: Oct. 15, 2026

(54) PERSONALIZING AI MODEL WITH PREFERENCE-BASED ACTIVATION STEERING

(71) Applicant: GOOGLE LLC, Mountain View, CA (US)

(72) Inventors: Yi Fei Bo, Richmond (CA); Tianyu Xu, Mountain View, CA (US); Ishan Chatterjee, Seattle, WA (US); Katrina Hannover Passarella-Ward, Alameda, CA (US); Achin Kulshrestha, Toronto (CA); Dongeek Shin, San Jose, CA (US)

(21) Appl. No.: 19/643,357

(22) Filed: Apr. 9, 2026

Related U.S. Application Data
(60) Provisional application No. 63/786,280, filed on Apr. 9, 2025.

(51) Int. Cl. G06F 16/9535; G06F 16/957

(52) U.S. Cl. CPC G06F 16/9535; G06F 16/957

(57) ABSTRACT

Disclosure relates to controlling AI responses through preference-based activation steering. A prompt is received and associated with a preference represented as a specific position within a range between two opposing features associated with the preference (e.g., luxury vs. budget related to cost preference). This position, which indicates which feature is favored and by how much, is set via interactive user interface inputs across multiple modalities: direct selection of candidate preferences (select implementation), iterative calibration between model-generated responses (calibrate implementation), or learning from interactions (learn implementation). Based on the position determined from the input, a corresponding steering strength of the position is injected into the model's stream to influence response generation. This allows the AI to align its output with the favored features/attributes. The system enables dynamic adjustment of responses through multiple interactions, where each interaction updates the position to refine the personalization in real-time.

### CROSS REFERENCE TO RELATED APPLICATION

This application claims the benefit of U.S. Provisional Application No. 63/786,280, filed Apr. 9, 2025, the disclosure of which is incorporated herein by reference in its entirety.

### BACKGROUND

Computer systems with artificial intelligence (AI) capabilities process and generate natural language data. These systems function by executing natural language processing algorithms to produce output based on large-scale datasets. AI is becoming a tool for interacting with technology in a simple, intuitive way across a wide range of applications to generate precise outputs across diverse computational applications.

### SUMMARY

The present disclosure describes a method and system for personalizing conversational generative models to generate responses to a prompt in accordance with one or more preferences associated with the prompt, without demanding complex instructions or reliance on a long history of prior conversations or interactions.

This disclosure relates to techniques for generating responses using a generative model (for example, an artificial intelligence (AI) model, large language model, large vision model, multimodal model, and the like) based on a preference associated with a prompt. The disclosed system with AI capabilities enables control over how the generative model produces responses by specifying both the preference and the strength of bias with which the preference is applied.

The disclosure relates to controlling AI responses through preference-based activation steering. A prompt is received and associated with a preference represented as a specific position along a continuum between two opposing features associated with the preference (e.g., luxury vs. budget related to cost preference). This position, which indicates which feature is favored and by how much (e.g., a direction and magnitude of bias), is set via interactive user interface inputs across multiple modalities: direct selection of candidate preferences (referred to as select implementation), iterative calibration between model-generated responses (referred to as calibrate implementation), or learning from interactions (referred to as learn implementation). Based on the position determined from the input, a corresponding steering strength of the position is injected into the model's stream to influence response generation. This enables the AI to align the probability distribution of its output with the favored features/attributes. The system enables dynamic adjustment of responses through multiple interactions, where each interaction updates the position to refine the personalization in real-time.

In some aspects, the techniques described herein relate to a computer-implemented method, including: identifying a preference associated with a prompt, wherein the preference is associated with a first feature and a second feature; determining, based on an input, a position within a range defined using the first feature and the second feature; providing the position within the range to a model to modify generation of a response to the prompt based on the position; receiving, from the model, the response to the prompt; and initiating display of the response.

In some aspects, the techniques described herein relate to a computing system including: at least one processor; and a memory communicably coupled to the at least one processor, the memory storing instructions that, when executed by the at least one processor, cause the computing system to: identify a preference associated with a prompt, wherein the preference is associated with a first feature and a second feature; determine, based on an input, a position within a range defined using the first feature and the second feature; provide the position within the range to a model to modify generation of a response to the prompt based on the position; receive, from the model, the response to the prompt; and initiate display of the response.

In some aspects, the techniques described herein relate to a computer program product including a non-transitory storage medium, the computer program product includes instructions that, when executed by processing circuitry, cause the processing circuitry of a computing system to perform a method, the method including: identifying a preference associated with a prompt, wherein the preference is associated with a first feature and a second feature; determining, based on an input, a position within a range defined using the first feature and the second feature; providing the position within the range to a model to modify generation of a response to the prompt based on the position; receive from the model, the response to the prompt; and initiating display of the response.

### BRIEF DESCRIPTION OF THE DRAWINGS

FIG. 1 illustrates a conceptual diagram of steering generation or customization of response based on a preference using distinct AI-based conversational interfaces, according to disclosed implementations;

FIG. 2 illustrates a conceptual diagram of steering generation or customization of response based on a preference selected from candidate preferences using an AI-based conversational interface related to a select aspect, according to disclosed implementations;

FIG. 3A illustrates a conceptual diagram of steering generation or customization of response based on a preference selected from candidate responses using an AI-based conversational interface related to a calibrate aspect, according to disclosed implementations;

FIG. 3B illustrates a conceptual diagram of steering generation or customization of response based on a preference inferred from a prompt using the AI-based conversational interface related to the calibrate aspect, according to disclosed implementations;

FIG. 4 illustrates a conceptual diagram of steering generation or customization of response based on a preference implied in responses using an AI-based conversational interface related to a learning aspect, according to disclosed implementations;

FIG. 5 illustrates an architecture diagram of components for generating or customizing response based on a preference, according to disclosed implementations;

FIG. 6 illustrates a flowchart of a process implemented on the computing system, according to disclosed implementations;

FIG. 7A illustrates an example of the select aspect, according to disclosed implementations;

FIG. 7B illustrates an example of the learning aspect, according to disclosed implementations;

FIGS. 8A, FIG. 8B, FIG. 8C, FIG. 8D, and FIG. 8E illustrate the effect of expressed preferences and perplexity-normalized effect for preferences and models, according to disclosed implementations;

FIG. 8F illustrates correlation of cosine similarity between the preference dimensions, according to disclosed implementations;

FIG. 9A and FIG. 9B show an example learned strength levels and preference effects, according to disclosed implementations;

FIG. 10 illustrates examples of personalization tasks implemented using a standard interface and the interfaces provided by the present technical solution, according to disclosed implementations;

FIG. 11A illustrates correlation between the applied steering strength and the effect of the preference expressed in the LLM's output, according to disclosed implementations;

FIG. 11B illustrates correlation between the participant's ground truth preference and the effect of the preference expressed in the LLM's output, according to disclosed implementations;

FIG. 12 illustrates data of each steerable chatbot matched to the user's preference with proportion agreement of preferences and mean error of the steering strengths, according to disclosed implementations;

FIG. 13 illustrates an example progression of the learned steering strengths 1302 across participant conversations 1304, according to disclosed implementations;

FIG. 14 illustrates perception results of chatbots, according to disclosed implementations; and

FIG. 15 illustrates an example of a computer system according to disclosed implementations.

### DETAILED DESCRIPTION

This disclosure provides a way for a user to quickly personalize how an AI assistant responds without requiring high-token-count prompt instructions. Instead of utilizing expanded natural language context windows, the system utilizes discrete control inputs—such as a scalar selection (like a slider) or a comparative (“this vs. that”) choice—to modulate the internal activation states of the AI assistant.

For example, if a user is looking for a place to eat, the user might set a preference for “Budget” to see affordable options like local diners. This “Budget” preference represents a vector direction in a latent space. If the user later changes the preference to “Luxury,” (a second direction in the latent space), the AI shifts its suggestions to high-end, fine-dining restaurants. The system works by turning these user choices into a mathematical “steering factor” for the latent space that guides the AI's internal decision-making process in real time. By injecting a scaled steering vector directly into the residual stream of the generative model's architecture, the system shifts the model's processing trajectory within the latent space, enabling the production of outputs aligned with specific parametric constraints, making the assistant feel more like it truly understands the user's distinctive taste.

Generally, computer systems that generate responses, such as text, audio, video, hyperlinks, or other web resources, rely on written or spoken natural-language instructions to determine the nature of the output to be produced. However, a technical problem arises in scenarios where characteristics of responses are not mapped to discrete natural language tokens, for example, responses are not mapped or relevant to preferences expressed in natural language, i.e., the same request may correspond to widely varying expected outcomes. Another technical problem associated with personalizing responses generated by large language models (LLMs) is that existing approaches rely on users to manually craft prompts that reflect their preferences. This process is challenging, as users first identify their preferences for a given task and then translate those preferences into natural language instructions suitable for inclusion in a prompt that is understandable or interpretable by the LLM. The process is repeated across different tasks and contexts, making it time-consuming, tedious, and often beyond the capability of many users.

Furthermore, natural language expressions of preference do not map reliably to a continuous or linear control space for influencing LLM outputs, nor do they provide a consistent parametric, semantic, or operational representation of the target output (user intent). For example, a user may request restaurant recommendations while preferring inexpensive options (a first target attribute) but also desiring a premium or aesthetically appealing ambiance (a second target attribute). If such target attributes are not explicitly and consistently quantified in the input vector, the system may produce inconsistent or irrelevant responses. As another example, phrases such as “I like X a little” and “I like X sometimes” may be interpreted inconsistently across users and contexts, and do not provide a standardized, quantifiable, or structured mechanism (e.g., parametric, vector-based, or programmatic controls) for influencing model behavior.

Some techniques, such as retrieval-based augmentation (RAG), may be used to guide outputs of large language models (LLMs) by incorporating external data sources that reflect user preferences. However, such approaches possess inherent technical limitations, such as the collection, storage, and retrieval of significant user-specific data, thereby increasing system latency and computational overhead, including memory (e.g., expanded input token counts) and bandwidth consumption. Similarly, fine-tuning an LLM to reflect user preferences involves significant amounts of user-specific training data and is generally impractical in cold-start scenarios involving new or unknown users.

The present disclosure describes technical solutions to address the computationally intensive and resource-heavy nature of retrieval-based augmentation (RAG) and fine-tuning approaches, by applying activation steering to the personalization of LLMs. Unlike RAG, which operates at the input level, the disclosed system utilizes a specific data transformation process that maps non-linear preference inputs into a discrete, parametric control space for direct injection into the model's residual stream. This enables the system to modulate the model's internal activation states during a single forward pass, providing a standardized and precise modification of the output distribution. This approach eliminates the need for external data retrieval or expanded context windows, thereby reducing the computational footprint and memory-intensive overhead associated with traditional personalization methods.

With activation steering, the disclosed techniques relate to generating responses using a conversational generative model, for example, an artificial intelligence (AI) model, an LLM, a large vision model, or a multimodal model, based on a preference associated with a prompt. As used herein, a conversational generative AI model refers to a machine-learned model configured to generate outputs of responses, such as text, audio, video, hyperlinks, or other content, in response to inputs including prompts, interactions, or sequences of interactions. The technical solutions enable control over how the conversational generative AI model produces responses by allowing specification of the preference and a corresponding strength of bias with which the preference is applied. Additionally, the technical solution involves a specific data transformation process that maps non-linear, subjective human preferences into a discrete, parametric control space. By applying activation steering, the system transforms user intent, received through various input modalities, into a quantifiable scalar factor. This scalar factor is used to scale a pre-computed steering vector, which is then injected into the internal activation states of the model. This approach provides a technical improvement over natural language prompting by enabling a standardized, repeatable, and precise modification of the model's output distribution without the memory-intensive overhead of RAG or the computational cost of weight-based fine-tuning.

In various implementations, the technical solution is related to performing activation steering for controlling generation of outputs of a conversational generative AI model. The activation steering involves performing a preference identification process to identify a preference associated with an input including, but not limited to, prompts, interactions, exchange of communications, or sequences of interactions. As used herein, a preference refers to an attribute expressed, specified, or inferred from the input that influences how an output of the conversational generative AI model is generated. The preference may be explicitly provided in the input or implicitly inferred from the input or prior interactions. The term “preference” is used broadly and may correspond to a trait, type, dimension, aspect, element, feature, preference dimension, or characteristic of the output. In some implementations, a “preference” is a quantifiable parameter representing a relative bias toward a specific characteristic of generated content. In some cases, a preference is a steerable dimension of generative output defined by a pair of opposing thematic or stylistic features or a parametric constraint applied to a model's residual stream to bias the probability distribution of generated tokens toward a specific characteristic. A preference may be defined by a position on a continuum between a first feature and a second feature, wherein the position acts as a weighting factor to steer model generation. Such preferences may include dimensions, traits, or characteristics associated with a user or a prompt received from a user. For example, in a restaurant recommendation scenario, a preference may correspond to cost, ambiance, culture, or age suitability that may be used as input (i.e., steering strength or steering parameter/vector) into the conversational generating AI model to generate recommendations related to those preferences/attributes.

In various implementations, each identified preference is associated with distinct features corresponding to that preference. The features may include two alternative features defining opposing ends of the preference, with one feature representing one end and another feature representing an opposite end. Additional features or values between the ends represent intermediate forms of the preference.

The features of the preference may be represented in the form of a range of values. As used herein, a “continuum” may also be referred to as a range, spectrum, scale, or other arrangement that represents variation or gradation between alternative features of the preference, including features at opposing ends. The range (continuum) represents the distinct features between the alternative features. The representations of the distinct features correspond to different forms, levels, or variations of the preference, including intermediate forms between the opposing ends. The representations indicate relative strength of bias or degree/level of bias or magnitude of bias of the preference. In various implementations, a “continuum” is a quantifiable range, spectrum, or scale representing a gradation between alternative features of a preference. The continuum defines a set of positions between opposing features, where each position corresponds to a specific magnitude and direction of bias. Technically, the continuum serves as a mapping between a user-selected value and a parametric adjustment applied to the model's internal representations, indicating the relative strength or level of bias for the preference.

In some implementations, each of the distinct features within the continuum may be associated with an underlying strength or value (also referred to as a steering vector, parameter, or strength of bias). The values may be represented numerically, categorically, or using other representations, and are used to indicate different levels or forms of the preference along the continuum, such as low, medium, or high levels of a preference or corresponding numerical ranges. Additionally, each strength or value along the continuum corresponds to a different magnitude and direction of bias toward one of the alternative features. In this manner, the continuum represents gradations between the alternative features rather than discrete selection of the features alone.

For example, when the preference corresponds to cost, the alternative features may include low-cost at one end and high cost at an opposing end, and the continuum represents varying levels of cost (as traits/attributes) between these features. When the preference corresponds to ambiance, the alternative features may include casual at one end and formal at an opposing end, and the continuum represents varying levels of ambiance (as traits/attributes) between these features. When the preference corresponds to age suitability, the alternative features may include child-oriented at one end and adult-oriented at an opposing end, and the continuum represents varying levels of age suitability (as traits/attributes) between these features. In another example, when the preference corresponds to level of detail, the alternative features may include a simplified explanation at one end and an advanced explanation at an opposing end, and the continuum represents varying levels of detail (as traits/attributes) between these features. In each example, the continuum defines a range of possible values for the preference between the alternative features. The preference, as represented along the continuum, is used to control generation of the output by the conversational generative AI model. In various implementations, a preference is present according to user settings of the application or global application settings when the system is accessed. This means that a preference is identified for a specific prompt, and a corresponding position on the continuum, is established as a baseline configuration for the prompt. For example, a user who has globally set a ‘Budget’ preference in their profile will have the cost continuum pre-initialized at a negative steering strength by default. Likewise, a ‘Budget’ preference may be set by an entity associated with the conversational generative AI model (i.e., an organization providing the model as a service). This pre-initialized preference ensures that the generative model provides a baseline of personalization even in the absence of explicit real-time tuning, which can then be further refined or overridden through the interactive modalities (select, calibrate, or learn) described herein. In various implementations, the initial state of a preference and its corresponding position on the continuum are determined not only by the immediate prompt but are also initialized according to user settings of the application or global application settings when the system is accessed. For example, a user who has globally set a ‘Budget’ preference in their profile will have the cost continuum initialized at a negative steering strength by default, which can then be further refined or overridden through the interactive modalities (select, calibrate, or learn) described herein. This initialization ensures that the generative model provides a baseline of personalization even in the absence of explicit real-time tuning.

Referring to activation steering, in various implementations, activation steering is used to manipulate or control the output of the conversational generative AI model (e.g., the LLM) based on the input including the preference and a corresponding strength of bias. The technical solution involves determining steering strength, also referred to as the strength of bias, for the preference, where the steering strength depends on the selection of the preference and a position on a continuum, the position reflecting the strength of bias (i.e., steering strength) of the preference. As used herein, the term “strength of bias” or “steering strength” may also be referred to as a steering parameter or steering vector and represents a factor, along with a value, used to influence the preference during generation of the response output. In other words, the steering strength modifies the response generation to favor the preference. In various implementations, as used herein, “strength of bias” is defined as a quantifiable scalar factor used to scale a steering vector to control the intensity with which a preference influences the generation of a response, or a weighting coefficient used to adjust the internal activation states of a generative model architecture during the inference phase.

To determine the strength of bias, the technical solution presents diverse interaction methods, for example, chatbot interface designs for obtaining the strength of bias. Each of the diverse interaction methods, also referred to as activation steering methods, can be effective at different intensities of strength, can be performed in conjunction with preference-based prompting, can improve persistence of personalization in longer contexts, and can be compounded as multi-preference targets. The disclosed techniques also provide an effective way to personalize chatbots in cold-start conversations with real end-users. For example, the strength of bias (or steering strength) can be determined and updated based on inputs received via a user interface using multiple modalities, and the strength of bias can be exposed using different interface designs. These interface designs allow manipulation of variables and internal representations of the LLM in a variety of manners.

One manner that may be used in the user interface is direct manipulation, referred to as a “select” aspect. In a direct manipulation modality (select), when a prompt is received or interpreted via a chatbot interface, a preference is identified. For example, when the prompt relates to searching for vacation spots, the conversational generative AI model may identify candidate preferences such as ambiance, cost, age, time, or culture. Simultaneously or concurrently with identification of the candidate preferences, the graphical user interface (GUI) may present the candidate preferences as user interface controls, including corresponding control elements representing a continuum of the preference.

Each continuum is defined between alternative features corresponding to opposing ends of the preference. For example, for a cost preference, the alternative features may include low-cost and high-cost; for an ambiance preference, the alternative features may include casual and formal; for an age suitability preference, the alternative features may include child-oriented and adult-oriented; and for a level of detail preference, the alternative features may include a simplified explanation and an advanced explanation. Such control elements for presenting the continuum may include a slider, dial, knob, dropdown menu, toggle, input field, or other selectable interface element that enables selection along the continuum of the preference. Through selection of one or more controls, one or more preferences may be selected from the candidate's preferences. Simultaneously or concurrently with the selection of the preference, a strength of bias along the continuum between the alternative features is selectable.

A point of selection on the continuum corresponds to a position on the continuum. As used herein, the position on the continuum represents a selected level or magnitude of the preference and corresponds to a strength of bias toward one of the alternative features at the opposing ends of the continuum. The continuum is bidirectional, such that positions on one side correspond to bias toward a first feature and positions on the opposite side correspond to bias toward a second, opposing feature, including positive and negative directions of bias. Based on the selected position, the strength of bias (i.e., steering strength) is determined and provided as input to the generative AI model to modify the internal residual stream of a multi-layer architecture (e.g., internal states and representations) of the model during inference for generation of a response to the prompt based on the preference. In some implementations, a “position” is a discrete numerical value within a bounded range representing a selected level or magnitude of a preference. Based on the selected position, the strength of bias (i.e., steering strength) is determined as a scalar factor and provided as input to the generative AI model to modify activation states within the residual stream of the model during inference for generation of a response to the prompt based on the preference. A bidirectional continuum represents a range between two opposing features (e.g., ‘Budget’ vs. ‘Luxury’). In some implementations, the bidirectional continuum may represent variation along a single feature/dimension, for example, a feature changes from lower to higher intensity. For example, if a preference for “Technicality,” the system initializes a continuum at a chosen level of technical depth. As the level increases, responses progressively incorporate more specialized terminology and detailed explanations.

In this manner, generation of the response is modified or steered using the preference and the corresponding strength of bias as a steering strength or a steering parameter. In various implementations, the strength of bias or steering strength (also referred to as a steering parameter or steering vector) may be a linear strength factor. This enables diverse interaction modalities for the “select” aspect design, allowing direct manipulation via a slider or other similar control that dynamically updates the steering strength applied to the conversational generative AI model during inference. This provides the user with control over a personalization factor used to personalize the generative AI model and influence generation of the response.

Another manner that may be used in the user interface is a sampling-based calibration mechanism, referred to as a “calibrate” aspect. The user interface may include sampling-based calibration elements configured to present calibration questions to learn a user-specific preference model or a user's reward model for their preferences. The disclosed calibrate methods focus on sampling candidate outputs and calibrating to an underlying strength of bias or steering strength of the user.

In various implementations, a calibration step may be performed prior to or during a conversation to iteratively converge on a user's selected preference and strength of bias (also referred to as steering strength). This user interface method is referred to as a calibrate design. In the calibrate design, the conversational generative AI model generates multiple candidate responses for prompt using different steering strengths. In some examples, the steering strengths may correspond to different positions along a continuum of preference similar to the select aspect. In other examples, the different steering strengths or positions may be selected or determined based on preset values associated with a type of prompt or selected based on strength of bias or values along the continuum of the preference. The candidate responses are presented to the user, and the user is prompted to select a response or indicate a strength of bias (or in some examples, degree of preference) between the candidate responses. In some implementations, the selection or rating is used to update the steering strength for a subsequent pair of responses or a final response, thereby iteratively refining the position along the continuum associated with the preference that updates the strength of bias of the preference as well. The sampling and update process may be implemented using various techniques, including iterative sampling, improvement-based updates, or simpler heuristic approaches.

In the sampling-based calibration modality (calibrate), when a prompt is received or interpreted via a chatbot interface, at least one preference is identified. Based on the identified preference, the conversational generative AI model generates at least a first candidate response and a second candidate response to the prompt, wherein the candidate responses correspond to different steering strengths of the identified preference. The candidate responses are presented via a user interface as selectable components.

For example, for a prompt requesting an explanation of a concept, the conversational generative AI model may generate a first candidate response providing a simplified explanation and a second candidate response providing a detailed or advanced explanation. In this example, the preference corresponds to the level of detail, and the continuum is defined between a simplified explanation and a detailed explanation as opposing features representing opposing ends of the preference. The continuum includes intermediate levels between these opposing features, for example, levels corresponding to a slight bias toward the simplified explanation, a moderate bias toward the simplified explanation, an approximately balanced preference between the simplified and detailed explanations, a slight bias toward the detailed explanation, or a moderate bias toward the detailed explanation. In some implementations, the user interface presents selectable user interface options corresponding to different strengths of bias between the candidate responses. The selectable options may include, for example: a strong preference toward the first candidate response, a moderate preference toward the first candidate response, a slight preference toward the first candidate response, equal preference between the first and second candidate responses, a slight preference toward the second candidate response, a moderate preference toward the second candidate response, or a strong preference toward the second candidate response. Additional options may include selections indicating “more of the first candidate response and less of the second candidate response” or “more of the second candidate response and less of the first candidate response.” Selection of one of the candidate responses or one of the selectable user interface options identifying the strength of bias is used to determine or update the position on the continuum corresponding to the strength of bias. Thus, a selection along the continuum corresponds to a position on the continuum. As used herein, the position represents a selected level or magnitude of a preference and corresponds to a strength of bias toward one of the alternative features at opposing ends of the continuum. The continuum is bidirectional, such that positions in one direction indicate bias toward a first feature, while positions in opposite direction indicate bias toward a second, opposing feature, including positive and negative directions of bias.

In various implementations, determining the position and the steering strength is performed iteratively across multiple selections of responses or interactions, wherein subsequent candidate responses are generated using updated steering strengths based on prior selections of strengths of bias. For example, after a selection indicating a strength of bias is received, the conversational generative AI model generates subsequent candidate responses using the corresponding steering strength and presents either a response to the prompt or the subsequent candidate responses via the user interface for further selection.

The process of presenting candidate responses, receiving a selection indicating a strength of bias, determining a corresponding position on the continuum, and deriving an updated strength of bias may be iteratively carried out. In this manner, for each iteration, the selected strength of bias is applied to generate outputs of the conversational generative AI model in accordance with the preference. For example, for the prior prompt requesting an explanation of a concept, if the user selects an option indicating a moderate strength of bias toward a detailed explanation, a corresponding strength of bias is determined. The conversational generative AI model generates a subsequent set of candidate responses. For example, if a prior selection indicates a moderate strength of bias toward a detailed explanation, the conversational generative AI model generates a third response providing a moderately detailed explanation and a fourth response providing a more detailed explanation, such that both candidate responses correspond to refined levels within the detailed portion of the continuum. Then, another strength of bias between the subsequent candidate responses may be selected, and the selected strength of bias is applied to generate outputs of the conversational generative AI model in subsequent rounds.

In this example, following a selection indicating a strength of bias toward the detailed explanation, the alternative features representing the opposing ends of the continuum are updated to correspond to refined levels within the detailed portion of the continuum. In this manner, subsequent candidate responses are generated relative to updated opposing features that are closer to the previously determined position on the continuum. In some implementations, for each iteration, the alternative features representing the opposing ends of the continuum are dynamically updated based on the selected strength of bias from a prior iteration, such that the continuum is progressively re-centered around the previously selected position. The determined position is used to derive a steering strength representing the strength and direction of bias toward one of the opposing features, and the strength of bias is applied to generate a response to the prompt or subsequent candidate responses via the user interface for further selection, thereby personalizing outputs with in-depth tuning of the conversational generative AI model based on the preference.

Another manner that may be used in the user interface is a conversation-based learning mechanism, referred to as a “learning” aspect. In various implementations, conversation-based learning determines the strength of bias from sentiment-based feedback within a conversation. Specifically, the user interface updates a preference-associated strength of bias based on sentiment and intent expressed in user-provided text. In a learning modality, latent preferences are inferred by analyzing user inputs, including prompts, follow-up messages, or feedback, without requiring explicit selection via user interface controls.

In this modality, the conversational generative AI model determines the direction of bias and a corresponding strength of bias from the interaction. The direction of bias indicates which of the opposing features of a preference is favored, and the strength of bias indicates a magnitude of preference toward the favored feature. The direction and strength of bias are derived based on sentiment and intent expressed in the user's interaction and are used to generate subsequent responses aligned with the preference.

In some implementations, the determined strength of bias associated with a preference is presented via the user interface during interaction with the conversational generative AI model. The strength of bias is visually indicated in association with the conversation, such as along a continuum or through a corresponding indicator, and is updated based on user interactions. In the learn mode, a continuum may refer to a representation of variation between alternative features of a preference, where the variation is suggested from user interactions over time. The continuum is defined between a first feature and a second feature representing opposing ends of the preference and represents intermediate forms of the preference between the opposing features.

In this mode, the continuum is not directly exposed as a control element but is implicitly constructed and updated based on conversational inputs, feedback, and interactions. Each interaction contributes to determining a direction and magnitude of bias toward one of the alternative features, thereby identifying a corresponding position along the continuum. For example, when the preference corresponds to cuisine type, the continuum may be defined between a first feature corresponding to non-Asian cuisine and a second feature corresponding to Asian cuisine. Initial interactions may indicate no bias (e.g., a neutral position), while subsequent interactions (e.g., requesting Omakase options) may shift the inferred position along the continuum toward the Asian cuisine feature. The presented strength of bias is displayed alongside generated responses, enabling the user to observe how the strength of bias is applied during generation of responses and how it changes across interactions.

For example, for a prompt requesting a recommendation for clothing brands or stores, the conversational generative AI model may initially generate a response including a mix of budget-oriented and premium brands. In this example, the preference corresponds to a price range, and the continuum is defined between budget-oriented brands and premium brands as opposing features representing opposing ends of the preference. If the user responds with “I'm looking for something more affordable,” the conversational generative AI model analyzes the interaction to determine a direction of bias toward budget-oriented brands and determines a strength of bias or value based on the phrasing. For instance, the phrase “more affordable” may correspond to a moderate strength of bias toward the budget-oriented end of the continuum. In some implementations, the determined strength of bias is presented via the user interface as an indication associated with the conversation, such as a visual indicator, label, or control element reflecting the inferred preference. For example, the user interface may display an indicator showing “Preference: Budget-oriented (moderate)” or a graphical representation along a continuum between budget-oriented and premium. If the user instead states “I want high-end designer brands,” the conversational generative AI model determines a direction of bias toward premium brands and determines a strong strength of bias value. The updated strength of bias may similarly be presented via the user interface to reflect the change in the inferred preference.

Based on the determined strength of bias, the conversational generative AI model updates the strength of bias associated with the preference and applies the strength of bias to generate subsequent recommendations aligned with the inferred preference. In some implementations, the presented indication of the strength of bias is dynamically updated across multiple interactions, thereby providing transparency to the user regarding how the conversational generative AI model interprets and applies the user's preferences.

In various implementations, the user interface design includes user interface elements, controls, options, and components configured to implement one or more interaction modalities, including a direct selection modality, a sampling-based calibration modality, and an interaction-based learning modality. The user interface may concurrently present elements corresponding to multiple modalities within a single conversational interface, enabling the user to influence the generation of responses through explicit controls, selection between candidate responses, and implicit feedback derived from interactions.

In this manner, any of the multiple interaction modalities, in combination with activation steering using preferences and corresponding strengths of bias, modifies internal representations of a conversational generative AI model during inference to influence the generation of outputs. Specifically, activation steering is performed by applying a steering vector, where the steering vector represents a direction in an internal representation space of the model associated with the preference. The strength of bias is used to scale the steering vector, and the scaled steering vector is combined with an internal representation of the conversational generative AI model during generation of the output. Different strengths or values of the strength of bias produce different intensities of bias in the generated output along with the preference, thereby controlling how the output reflects the identified preference.

Further, any of the multiple interaction modalities, in combination with activation steering, constitutes a technical improvement in the functioning of the generative AI model by modifying its internal latent representations during inference. Specifically, the system performs a mathematical operation where a steering vector, representing a specific semantic direction in the model's internal representation space, is scaled by the determined strength of bias. This scaled steering vector is then added to the residual stream of the generative models architecture. This technical solution enables the system to steer the model's stochastic output generation toward a targeted characteristic with a high degree of mathematical precision, a capability not possible through natural language prompting alone. By manipulating the internal activation states directly, the system reduces the entropy of the output distribution relative to the identified preference, resulting in a more technically accurate and consistent response generation.

The present disclosure provides several technical advantages and benefits that improve the functioning of the computing system and the generative AI model itself. In various implementations, activation steering is performed without retraining or modifying model weights, thereby reducing computational cost, network resource usage, training time, and latency associated with retraining. By injecting steering vectors directly into the model's residual stream during inference, the system achieves a technical improvement in model control precision without the memory-intensive overhead of RAG. This technical approach transforms subjective natural language into a precise parametric control, solving the technical problem of semantic ambiguity in user prompts. Furthermore, the reduced computational and memory footprint allows high-quality generative inference to be performed on local, resource-constrained hardware, such as mobile devices or head-mounted displays, which otherwise lack the bandwidth or memory for large-scale fine-tuning or external data retrieval. This represents a shift in how generative models are controlled, moving from external prompting to internal architectural manipulation.

Activation steering also enables finer-grained control over generated outputs compared to existing prompting techniques, as a strength of bias is applied during inference to influence generation along a defined preference without modifying model parameters and without reliance on external data retrieval. By avoiding parameter updates and external retrieval operations, the disclosed techniques reduce memory usage, network dependency, and computational overhead relative to retrieval-based or fine-tuning approaches. The technical solution may be applied persistently or conditionally once preferences are determined, thereby enabling consistent personalization across interactions. The disclosed techniques do not require prior user-specific data and can operate in cold-start scenarios, allowing personalization without pre-existing user profiles or historical data. In some implementations, activation steering utilizes a pre-computed steering vector associated with a preference, and personalization is achieved by applying a strength of bias to the steering vector during inference. This enables learning and application of user preferences with reduced memory overhead, thereby providing a cost-efficient approach to personalization. The reduced computational and memory requirements of activation steering enable deployment in resource-constrained environments, including on-device applications such as mobile devices and extended reality (XR), augmented reality (AR), and virtual reality (VR) systems. As conversational AI systems are increasingly deployed on such devices, the disclosed techniques enable efficient adaptation of generative AI models in resource-efficient settings.

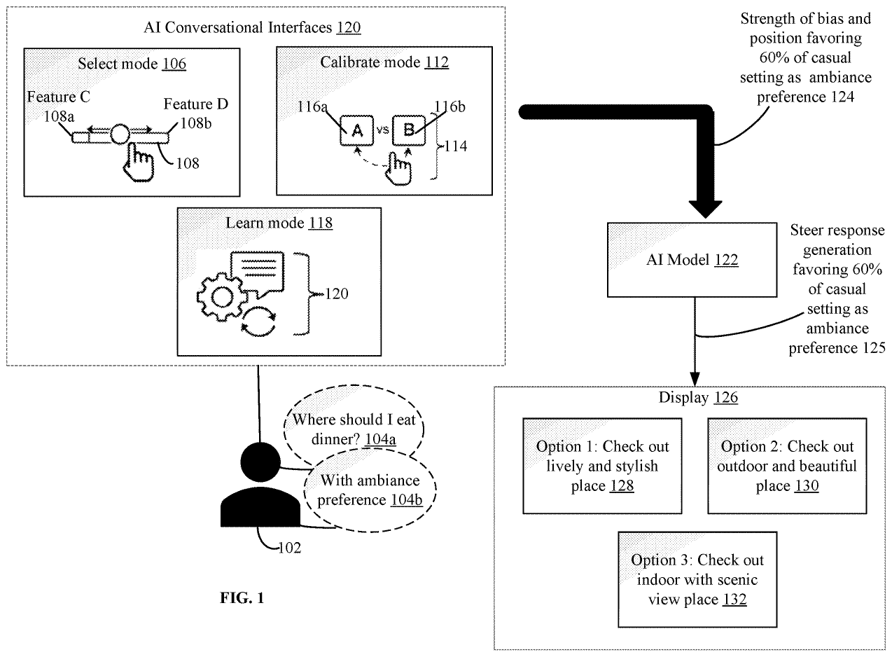

FIG. 1 illustrates a conceptual diagram of steering generation or customization of response based on a preference using distinct AI-based conversational interfaces 120. This figure shows an example system for enabling activation steering of a conversational generative AI model through multiple user interaction modalities. The system enables a user 102 to provide a prompt, for example, a prompt 104a asking “Where should I eat dinner?” along with an associated ambiance preference 104b, and to interact with AI conversational interfaces 120. The AI conversational interfaces 120 cooperate with AI model 122 to identify or determine a preference and a corresponding strength of bias associated with the prompt. Based on the identified preference and the corresponding strength of bias, the AI model 122 is configured to steer generation of responses and to generate and present personalized responses on a display 126.

The AI conversational interfaces 120 include multiple interaction modes for determining the preference and the corresponding strength of bias. In particular, the interfaces include a select mode 106, a calibrate mode 112, and a learn mode 118, each of which provides a different mechanism for obtaining input associated with the preference. These modes may be presented independently or in combination within a single conversational interface.

In the select mode 106, the user interface presents controls for different ambiances (candidate preferences) and a control element 108, such as a slider, positioned between alternative features C 108a and D 108b, which represent opposing ends of a preference. For example, the preference may correspond to ambiance, where one end represents a casual setting (feature C 108a) and the other end represents a formal setting (feature D 108b). User 102 interacts with the user interface to select the ambiance preference and further interacts with the control element 108 to select a position along a continuum between the alternative features. The selected position represents a strength of bias toward one of the alternative features and corresponds to a position on the continuum. For example, the user 102 may position the slider to indicate a strength of bias of approximately 60% toward the casual setting (feature C 108a).

In the calibrate mode 112, the user interface presents candidate responses or options, such as Option A 116a and Option B 116b, corresponding to different responses generated by the AI model 122 in response to a prompt 104a of the user 102, for example, “Where should I eat dinner?” along with associated ambiance preference 104b. When the preference corresponds to ambiance, the alternative features may include a casual setting as a first feature and a formal setting as a second feature, representing opposing ends of the preference. A continuum is defined between the casual setting and the formal setting, representing varying levels of ambiance between these features.

In this example, the first candidate option 116a may correspond to a response favoring a casual setting, such as suggesting a relaxed café or informal dining location, and the second candidate option 116b may correspond to a response favoring a formal setting, such as suggesting an upscale or fine dining restaurant. The candidate options therefore correspond to different positions along the continuum defined between the alternative features.

The user interface enables the user 102 to select between the candidate options or to indicate a preference between them using selectable elements 114. The selection indicates a strength of bias between the alternative features and is used to determine or refine a corresponding position on the continuum associated with the preference. In some implementations, this process is iterative, such that subsequent candidate options are generated and presented based on previously determined strengths of bias, thereby progressively refining the position along the continuum. For example, the user 102 may select Option A 116a, corresponding to the casual setting.

In the learn mode 118, the system determines the preference and corresponding strength of bias based on conversation/interactions 120, such as conversational inputs, feedback, or responses. In this mode, the system analyzes the user's input to infer a direction and magnitude of bias associated with the preference. The inferred preference and strength of bias may be updated dynamically over time based on ongoing interactions. The user 102 provides a prompt 104a, such as “Where should I eat dinner?”, along with an ambiance preference 104b. Based on the input and interactions through one or more of the interaction modes, the system determines a strength of bias and a corresponding position along a continuum for the identified preference. For example, the system may determine a position favoring 60% of a casual setting as an ambiance preference denoted by numeral 124, indicating a bias toward one of the alternative features associated with ambiance. The determined strength of bias and position are provided to the AI model 122, which uses the information to steer generation of a response. In particular, the strength of bias functions as a steering parameter that influences internal representations of the model during inference, thereby controlling how the response reflects the identified preference. For example, the AI model 122 generates a response favoring 60% of a casual setting as the ambiance preference denoted by numeral 125, consistent with the determined strength of bias.

The responses are provided to the display 126, which presents one or more responses or options to the user 102. For example, display 126 may present multiple options, such as a lively and stylish place (option 128), an outdoor and beautiful place (option 130), or an indoor place with a scenic view (option 132). These options reflect variations in the preference based on the applied strength of bias (i.e., favoring 60% of a casual setting as the ambiance preference). In this manner, FIG. 1 illustrates how multiple interaction modalities, select, calibrate, and learn, are used to determine a preference and a corresponding strength of bias, which is then applied to steer generation of responses by the AI model 122 and presented to the user via the display 126.

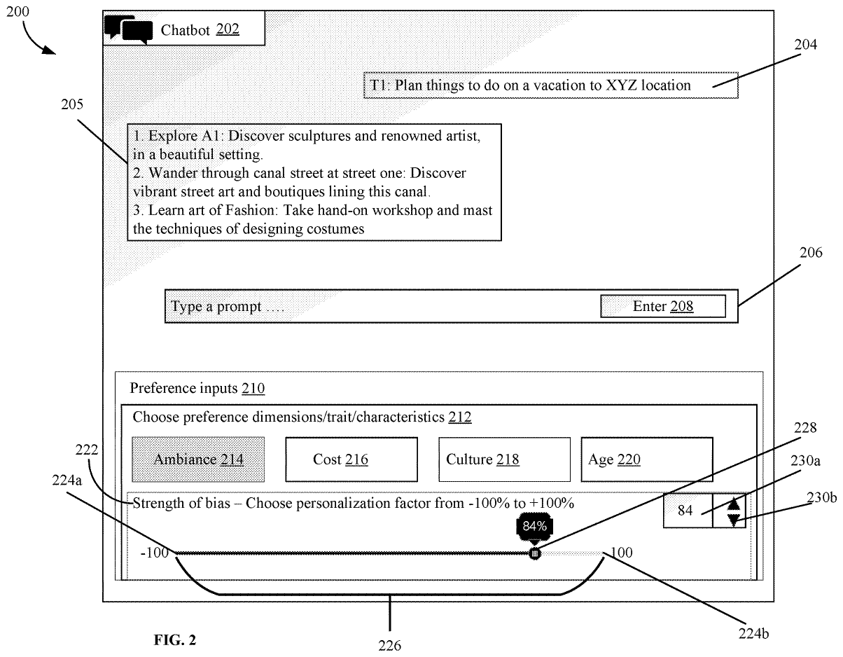

FIG. 2 illustrates a conceptual diagram of steering generation or customization of response based on a preference selected from candidate preferences using an AI-based conversational interface related to a select aspect 200. Chatbot 202 is presented and configured to enable selection of a preference and a corresponding strength of bias for controlling generation of responses. The user interface includes a conversational region 204 that allows the user 102 to input a prompt and view corresponding responses. Based on the prompt, one or more responses 205 may be generated and presented by the chatbot 202. For example, the user 102 may provide a prompt T1, such as “Plan things to do on a vacation to XYZ location,” which is displayed within the conversational region 204. In response, chatbot 202 generates and presents suggested activities, such as exploring art locations, walking through local streets, or participating in workshops, which are displayed within the conversational region.

The chatbot 202 further includes an input region 206, which enables the user 102 to enter subsequent prompts. The input region 206 includes a text input field and an input control 208 (e.g., an “Enter” button) for submitting the prompt to the system. Upon receiving the prompt via the input region 206, the system processes the prompt and generates responses that are displayed in the conversational region.

The user interface further includes a preference input region for receiving preference inputs 210, which enables the user 102 to specify preferences associated with the prompt. In various implementations, in addition to the prompt T1, the user 102 may provide preference inputs 210. Within the preference input region, the user interface presents selectable controls corresponding to different preference dimensions, traits, or characteristics 212, such as ambiance 214, cost 216, culture 218, and age 220. Each selectable control represents a candidate preference that may be associated with the prompt T1 or with a subsequent prompt entered in the input region 206. For example, for the vacation planning prompt, user 102 may select the ambiance 214 preference to influence recommendations based on the desired atmosphere or setting.

In response to selecting a preference (e.g., ambiance 214), the user interface presents a control 226, such as a slider, corresponding to the selected preference to provide a strength of bias 222 (that acts as a personalization factor from −100 to +100). The control 226 may be positioned along a continuum (i.e., control 226, e.g., the slider) defined between alternative features of the selected preference. For example, when the preference corresponds to ambiance, the alternative features may include a casual setting at one end (224a) and a formal setting at an opposing end (224b). The continuum between these features represents varying levels of ambiance between the alternative features.

The control 226 enables the user to select a position along the continuum, where the position corresponds to a strength of bias toward one of the alternative features. The user interface may display a numerical indicator 228 corresponding to the selected position, and input controls 230a and 230b may be provided to incrementally adjust the position. For example, user 102 may position the control 226 to indicate a strength of bias of approximately 84% toward the casual setting, indicating a preference for relaxed or informal environments. Based on the selected position along the continuum, the system determines a corresponding steering parameter representing the strength of bias associated with the selected preference. The steering parameter is provided to the AI model, which uses the steering parameter (as the strength of bias) during inference to generate responses aligned with the selected preference. For example, when the strength of bias indicates a preference toward casual settings, the chatbot 202 generates recommendations such as relaxed cafés, open-air venues, or informal attractions and presents them on the user interface.

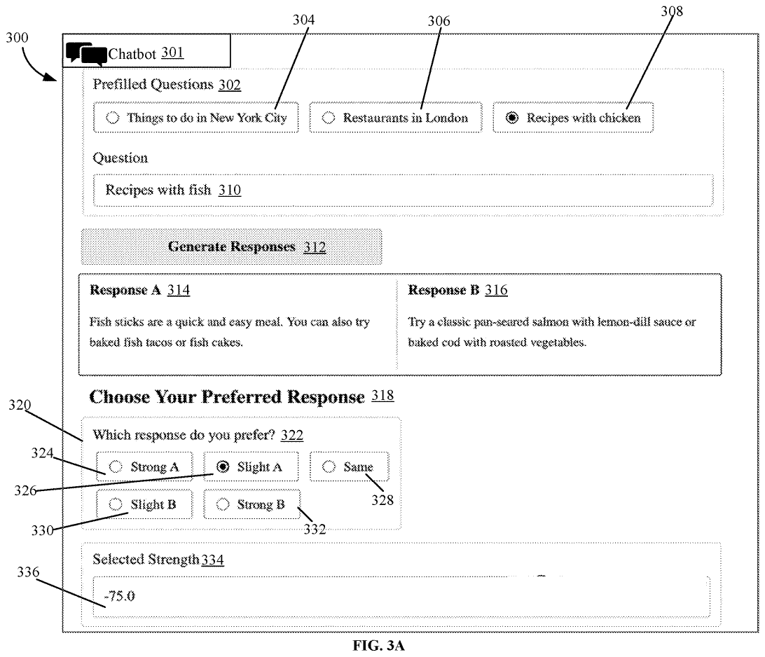

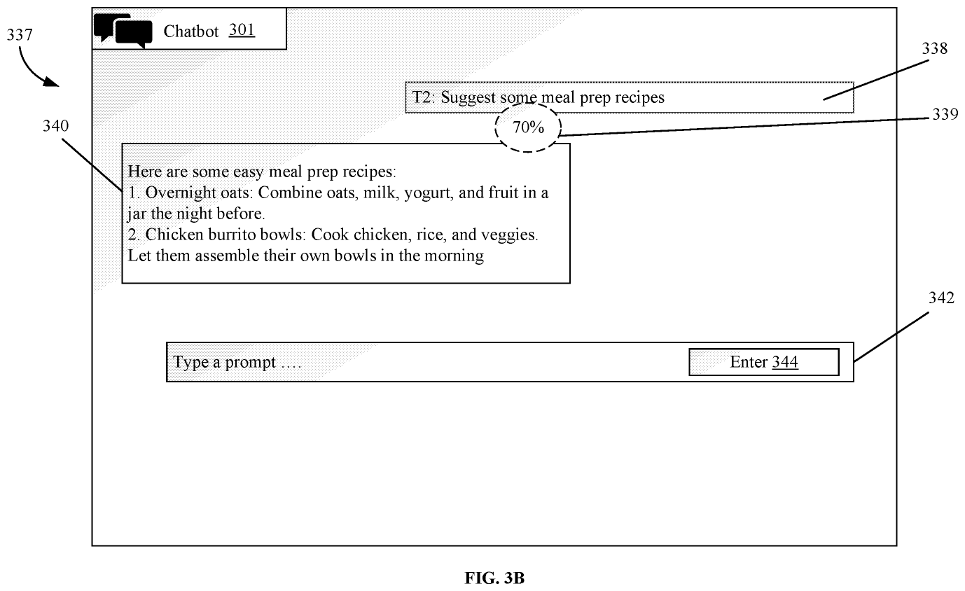

FIG. 3A illustrates a conceptual diagram of steering generation or customization of response based on a preference selected from candidate responses using an AI-based conversational interface related to a calibrate aspect 300. In the calibrate mode, a chatbot 301 may present prefilled questions 302 for user selection. The user may select any of the questions 304, 306, and/or 308 or may choose any of them as a base prompt. For example, the user may choose question 308 as a base and may change it to prompt 310. The user interface presents candidate responses or options, such as Response A 314 and Response B 316, generated by the AI model in response to the prompt 310 of the user. For example, the user may provide the prompt 310, such as “Recipes with fish,” which is entered via the question input field and submitted using the generate responses control 312. In response to prompt 310, the AI model generates multiple candidate responses that are displayed within the user interface. In this example, Response A 314 may include simple or quick meal suggestions, while Response B 316 may include more elaborate or refined recipes.

When the preference corresponds to a level of detail, the alternative features may include a simplified explanation as a first feature and a detailed explanation as a second feature, representing opposing ends of the preference. A continuum is defined between the simplified and detailed features, representing varying levels of detail between these features.

In this example, Response A 314 may correspond to a response favoring the simplified feature, while Response B 316 may correspond to a response favoring the detailed feature. The candidate responses may be presented as selectable components. Along with candidate responses, continuum varying strengths of bias between the opposing features may be determined and presented. The continuum 320 includes multiple levels of strength of bias between the opposing features, including, for example: a strong bias toward the simplified feature, a moderate bias toward the simplified feature, a slight bias toward the simplified feature, an approximately balanced preference between the features, a slight bias toward the detailed feature, a moderate bias toward the detailed feature, and a strong bias toward the detailed feature. In this manner, the continuum represents a bidirectional range of strengths of bias between the opposing features, rather than discrete selection of the candidate responses alone. Each of the features along the continuum 320 may be presented as selectable user interface options.

The user interface enables the user to indicate a preference between the candidate responses using selectable components within a preference selection region specifying “choose your response” 318. For example, the user may respond to the prompt “Which response do you prefer?” 322, by selecting one of multiple user interface options, such as Strong A 324, Slight A 326, Same 328, Slight B 330, or Strong B 332. Each option corresponds to a different strength of bias along the continuum 320 between the opposing features, thereby indicating both a direction and magnitude of preference. The selected option is used to determine a corresponding position on the continuum 320, which is represented as a strength of bias, such as a numerical or encoded value 336 displayed in a region labeled “selected strength” 334 (e.g., −75.0, indicating a bias toward the simplified feature). The determined position reflects both the direction and magnitude of the preference and is used to steer subsequent response generation. In some implementations, this process is iterative, such that subsequent candidate responses are generated based on a previously determined strength of bias. The candidate responses may correspond to refined levels along the continuum that are closer to the previously selected position. The user may continue to select among options corresponding to different strengths of bias, thereby progressively refining the position along the continuum associated with the preference.

FIG. 3B illustrates a conceptual diagram of steering generation or customization of response based on a preference inferred from a prompt using the AI-based conversational interface related to the calibrate mode 337. The user interface includes a chatbot 301 and a conversational region that displays a prompt and corresponding response generated by the AI model. For example, the prompt T2, such as “Suggest some meal prep recipes,” 338, is displayed within the user interface. Based on a determined preference and corresponding strength of bias, the AI model generates a response 340 that reflects the applied bias. In this example, the preference corresponds to a level of detail, where alternative features include a simplified feature and a detailed feature, representing opposing ends of the preference. A continuum is defined between the simplified and detailed features, representing varying levels of detail between these features. A determined position on the continuum is indicated as a strength of bias 339, for example, approximately 70%, reflecting a bias toward one of the alternative features (e.g., toward the simplified feature).

The response 340 corresponds to the determined position on the continuum and reflects the strength of bias associated with the preference. For example, when the strength of bias favors the simplified feature, the response may include concise and easy-to-follow meal preparation suggestions, such as overnight oats or simple meal combinations, rather than more complex or detailed recipes. The response therefore represents a position along the continuum between the alternative features and is aligned with the determined strength of bias. The user interface further includes an input region 342 with an input control 344 (e.g., an “Enter” button) that enables the user to provide additional prompts or interactions. In some implementations, subsequent inputs received via the user interface may be used to further adjust the position on the continuum, thereby refining the strength of bias associated with the preference and influencing generation of subsequent responses.

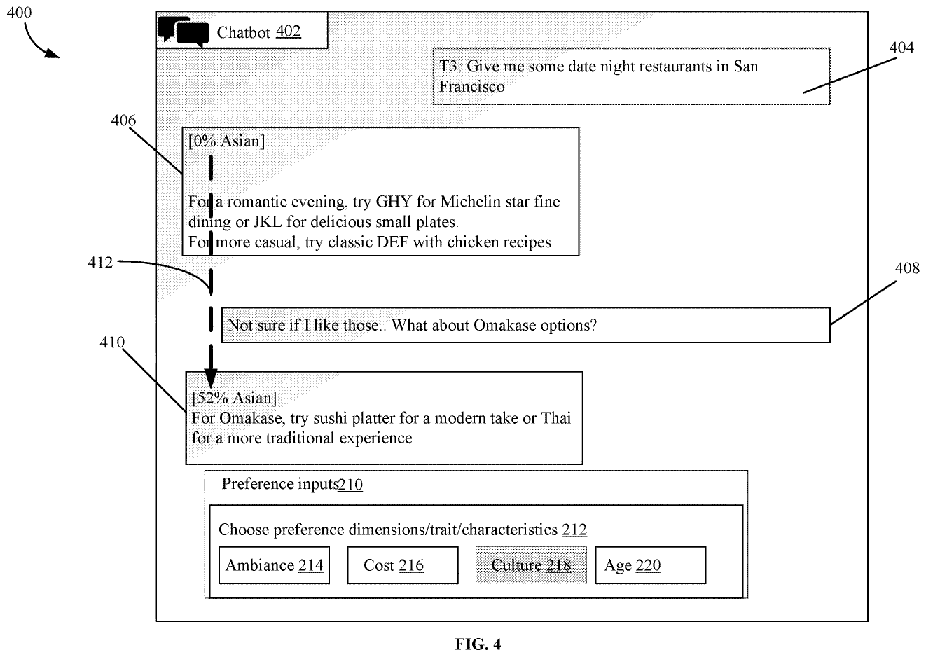

FIG. 4 illustrates a conceptual diagram of steering generation or customization of response based on a preference implied by responses using an AI-based conversational interface related to a learning aspect 400. In the learning mode, a chatbot 402 may be presented on the user interface of the computing system. In this mode, the system determines a preference and a corresponding strength of bias based on user interactions, such as conversational inputs, feedback, or responses. The system analyzes user-provided inputs to infer both direction and magnitude of bias associated with a preference. The inferred preference and corresponding strength of bias are dynamically updated over time based on ongoing interactions. As illustrated in FIG. 4, a user may provide a prompt 404, such as “Give me some date night restaurants in San Francisco.” In response, the system generates an initial response 406 that may reflect a default or previously inferred preference. For example, the response may correspond to a cuisine-related preference, such as a 0% Asian preference, indicating no bias toward a particular cuisine type at an initial stage. The generated response is presented in the conversational interface.

The user may then provide a follow-up interaction 408, such as “Not sure if I like those . . . . What about Omakase options?” This interaction provides implicit feedback indicating a shift in preference toward a specific cuisine type. The system processes this interaction and infers an updated preference and corresponding strength of bias. For example, the system may determine an updated strength of bias of 52% toward Asian cuisine, as indicated by reference numeral 412. This updated strength of bias reflects both the direction (toward Asian cuisine) and the magnitude (degree of preference) inferred from the user's interaction.

The determined strength of bias is visually presented to provide transparency regarding how the system interprets the user's preferences. For example, the strength of bias may be displayed as an annotation (e.g., “[52% Asian]”) associated with the generated response, allowing the user to understand how the preference influences the response. This visual representation enables the user to verify, adjust, or refine the inferred preference through subsequent interactions.

Based on the inferred and updated strength of bias, the system determines a corresponding position along a continuum defined between alternative features of the preference. The strength of bias functions as a steering parameter that is provided to the AI model and applied during inference to influence internal representations of the model. As a result, the AI model generates a response 410 that reflects the updated preference, such as suggesting Omakase, sushi, or other cuisine options aligned with the inferred bias toward Asian cuisine. In this manner, the learning mode enables continuous and adaptive personalization, where the preference and corresponding strength of bias are inferred and refined over time based on natural conversational interactions. The visual presentation of the strength of bias within the user interface enhances interpretability and user control, while the application of the steering parameter ensures that subsequent responses are aligned with the evolving preferences of the user.

Additionally, FIG. 4 illustrates that elements of the select design may be presented in conjunction with the learn mode interface. In particular, the user interface may include controls corresponding to a select mode, such as selectable preference dimensions and associated control elements, which may be provided alongside conversational interactions. For example, the preference input region for choosing preference inputs 210, including selectable controls for preference dimensions such as ambiance 214, cost 216, culture 218, and age 220, may be presented within the same interface used for learning mode interactions. In this manner, the interfaces may include a select mode, a calibrate mode, and a learn mode, each providing a different mechanism for obtaining input associated with a preference. These modes may be presented independently or in combination within a single conversational interface, thereby enabling the system to determine and refine a preference and a corresponding strength of bias through multiple interaction modalities.

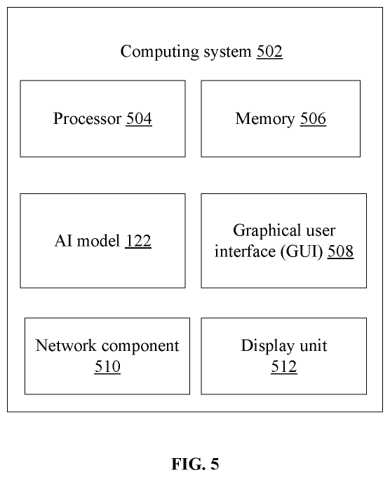

FIG. 5 illustrates an architecture diagram of components for generating or customizing a response based on a preference. The computing system 502 may include a desktop computer, notebook or laptop computer, netbook, tablet computer, e-book reader, global positioning system (GPS), personal digital assistant (PDA), handheld electronic device, cellular telephone, smartphone, augmented/virtual reality device, head-mounted display (HMD) device, head-wearable device, head-up display (HUD) device, smart glasses, mixed reality (MR) device, or other electronic devices.

In various implementations, the computing system 502 may comprise a processor 504, memory 506, AI model 122, graphical user interface (GUI) 508, a network component 510, and a display unit 512. These components cooperate to enable personalization of outputs of the AI model 122 by applying preferences and corresponding strengths of bias to generate responses to prompts in accordance.

Processor 504 may be configured to execute instructions stored in memory and coordinate the operation of components of the computing system 502. In various implementations, the processor 504 may be configured to perform operations including receiving inputs such as prompts, interactions, or sequences of messages, and processing the inputs to identify and determine one or more preferences. Processor 504 may further determine alternative features associated with each preference and define a continuum with the alternative features. Processor 504 may determine a position along the continuum and based on the position determines the strength of bias (i.e., a steering parameter) corresponding to the preference. Processor 504 further applies the steering parameter to modify internal representations of the AI model 122, thereby influencing generation of outputs. Processor 504 may include one or more processing units, such as central processing units (CPUs), graphics processing units (GPUs), or other specialized processors.

Memory 506 is communicatively coupled with processor 504 and stores instructions and data used by the computing system 502. The stored data may include a representation of AI model 122 (LLM), including representations of preferences, alternative features associated with each preference, continuum structures defined between the alternative features, and corresponding steering parameters or related data used to perform activation steering.

The AI model 122 may be configured as one or more generative or multimodal models, including LLMs. The AI model 122 may be implemented locally on a user computing device or accessed via remote systems, such as servers, cloud platforms, or distributed computing environments, to generate outputs in response to prompts or other inputs received by the computing system 502. During operation, processor 504 performs activation steering by determining a strength of bias associated with a preference and applying the strength of bias to a steering vector. Processor 504 provides the scaled steering vector as input to the AI model 122 by modifying internal representations of the model during inference, such that the generated outputs reflect a strength of bias toward one of the alternative features associated with the identified preference.

The graphical user interface (GUI) 508 enables interaction with the computing system 502. The GUI 508 may receive inputs including prompts, selections, and other interactions, and may present outputs generated by the AI model 122. In some implementations, the GUI 508 provides interface elements corresponding to different modalities for determining the steering parameter, including direct manipulation controls, selectable candidate outputs, and interaction-based updates.

In various implementations, the AI model 122 is configured to operate in conjunction with the GUI 508 to facilitate interaction between the computing system 502 and inputs provided via the user interface. In various implementations, the GUI 508 receives inputs such as prompts, selections, or interactions, and provides the inputs to the AI model 122 for processing. The AI model 122 interprets the received inputs and generates corresponding outputs based on the inputs and any applied processing, including activation steering.

The cooperation between the AI model 122 and the GUI 508 enables a continuous interaction loop in which inputs received through the GUI 508 are processed by the AI model 122, and resulting outputs are returned to the GUI 508 for presentation. This interaction may include receiving user-provided text, selections corresponding to preferences, or other forms of input, and generating outputs that reflect the processed inputs.

In some implementations, the GUI 508 further facilitates collection of inputs used to determine preferences and steering parameters, while the AI model 122 processes these inputs during inference to generate outputs that correspond to the determined preferences. In this manner, the GUI 508 serves as an interface for input and output exchange, while the AI model 122 performs computational processing of the inputs to produce the outputs.

The network component 510 enables communication between the computing system 502 and external systems or devices. For example, the network component 510 may facilitate communication with remote servers, cloud-based AI models, or other computing resources.

In various implementations, the display unit 512 presents outputs and interface elements to a user. The display unit 512 may be integrated with the computing system 502 or provided as an external component.

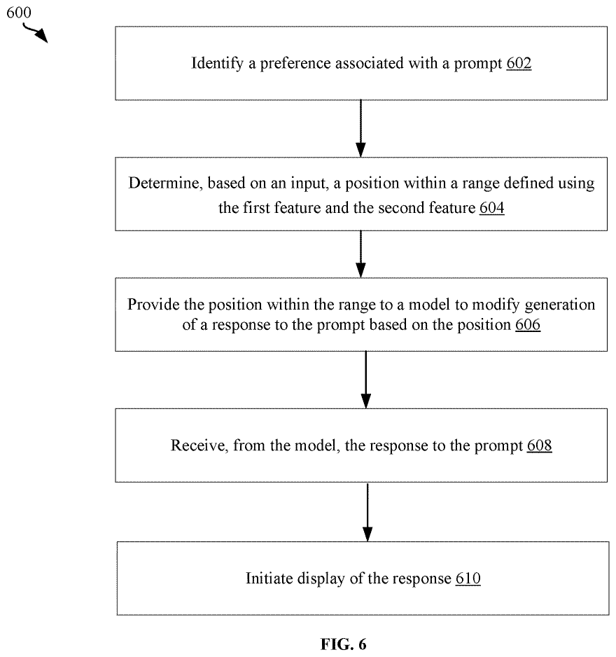

FIG. 6 illustrates a flowchart of a process 600 implemented on the computing system 502. Process 600 may be implemented for controlling generation of response using a conversational generative AI model, for example, AI model 122 including LLM. In this disclosure, LLMs improve in their capacity to serve as personal AI assistants; their ability to output distinctively tailored, personalized responses that align with the soft preferences of users is utilized for improving user satisfaction and retention. For instance, LLMs encode a powerful ability to generate responses tailored to the distinctive requests of the users, making them highly promising as personal AI assistants. In day-to-day tasks where preferences across the population can be highly variable, such as a user query like “Where should I eat dinner?”, it is vital for the LLM assistant to understand the user's underlying preferences quickly and incorporate them in its response persistently. However, in the current paradigm, LLMs are trained through reinforcement learning from human feedback (RLHF) to improve for the preferences of the population average. As a result, personalization techniques usually rely on retrieving prior mentions of preferences from long-term memory, which is not applicable to new users (cold-start scenarios) and can require extensive computation and memory. Also, lay users are notoriously bad at prompt specifications and often struggle with conveying their latent preferences to AI assistants. Lay users comprise a significant portion of commercial LLM users via the mainstream adoption of LLM chatbots. Despite their ever-growing popularity, non-technical users are prone to underspecifying their intent in queries and lack general intuition for creating structured and effective prompts. LLM outputs that fail to meet users' intent can negatively impact trust and perceptions, leading to reduced satisfaction and usability. Furthermore, underlying preferences can be difficult to infer; users may not even know how to communicate their own, as this commands an awareness of one's own preference relative to the population average. User-centered personalization seeks to capture soft preferences that align with user expectations, ensuring a satisfying interaction with the LLM. Preferences are often nuanced and layered, requiring contextualization against broader population trends. For example, a low-income user who mistakenly expresses, “I want to treat myself!” in her request for restaurant recommendations may not realize that the LLM is interpreting her preference as luxury-focused and suggests five-starred restaurants out of her budget range.

To address the technical limitations of existing systems, process 600 provides a technical solution to build and utilize LLM's capabilities to effectively guide generations to conform with the soft preferences of the user and leverages activation steering to guide LLMs to align with different interpretable preference dimensions during inference. This technical solution has benefits over memory-based personalization methods that require long user history; steering is extremely lightweight and easily controlled via a linear strength factor. The steering may be distilled into different interactive chatbot interfaces based on user study (n=14) to investigate how end users prefer to personalize their conversations. The results demonstrate the effectiveness of preference-based steering for aligning real-world conversations with user preferences. Qualitative findings further indicate that variations in user values relating to control, usability, and transparency of personalization correspond to preferences for different interface designs. For example, the technical method is validated through a set of robust computational experiments across distinct open-source LLMs, focusing on quantifying the effect of steering on preference expressions. Then, the steering is distilled into three chatbot interface designs encompassing diverse interaction methods.

In various implementations, activation steering is utilized as a promising method to consistently modify the outputs of LLMs towards desirable behaviors and content using inference-time injections of lightweight steering vectors. During forward inference, pre-computed vectors representing the desirable trait are added to representations at the residual stream of the LLM alongside a strength factor, which can effectively steer the output without degradation to quality. Steering offers potential benefits over other methods of personalization as it does not demand any re-training of model weights like fine-tuning; it offers finer control than natural language prompting; and it can be applied persistently or conditionally once the user's preferences are learned. Activation steering's low-resource requirements also make it a good candidate for on-device consumer applications, such as for mobiles and AR/VR technology. Thus, activation steering is utilized as a method for manipulating the internal states of LLMs at inference time to control the model's output without having to fine-tune the model. This is achieved by adding a “steering vector”, computed by extracting representations of a particular concept or behavior from the LLM's own internals to the residual stream of the generative model architecture. It has been commonly applied in AI safety and alignment to steer away from hallucinatory and harmful responses and to align with other desired behaviors, including adopting personas. The effect of steering can be further amplified, reduced, or even inverted through controlling the steering strength, a simple factor that is multiplied to the vector. This property of steering maps well to real-world preferences, which can be strong, weak, or opposite directions. In various implementations, the application of steering may be validated at different magnitudes and directions in preference-based tasks. In various implementations, activation steering may be applied towards controlling the preference-based content expressed by LLMs, such as in dimensions like cost, ambiance, and culture, which are highly relevant for AI-assisted lifestyle planning tasks like gift shopping and travel planning.

In various implementations, process 600 may involve presenting one or more distinct interface designs to receive the steering via one or more diverse modalities. Process 600 may provide personalization of interfaces to enable control of the steering and personalization factor via the chatbot interface. The first modality includes a select design, which permits direct manipulation via a slider that dynamically updates the steering strength applied to the LLM during inference. The second modality includes a calibrate design. A numerical representation of a preference may be subject to variation in interpretation across users. To account for this variability, a calibration process may be performed prior to or during a conversation to iteratively determine the strength of bias associated with the preference. The calibrate design may search for the most favorable parameters distinctive to the user through improving some reward signals and has been tackled through general methods like active learning, multi-arm bandits, Bayesian inference, and item response theory. In various implementations, the calibration algorithm generates pairwise responses with different steering strengths and asks users to rate their response, then updates the strengths for the next pair. A third modality includes learning design. In “learn”, an interactive approach may be employed to learn user preferences, which learns latent preferences through user edits as feedback, and user demonstrations. Specifically, the sentiment and intent of the user's utterance are captured and used to update the learned steering parameter throughout the conversation, allowing “behind-the-scenes” learning with less disruption to the interactions. For transparency, the learned steering parameter may be presented to the user. These three chatbot designs and modalities capture different design values and further demonstrate the flexibility of how steering can be exposed to users.

In various implementations, process 600 may utilize LLM activation steering methodology towards a framework for preference-based personalization and perform preference-based activation steering. For the steering personalization framework, the personalization objective is parameterized as follows. Given a task domain T (such as lifestyle planning) which demands highly variable solutions for each user, there are a set of relevant preference dimensions, d={d₁, d₂, . . . dₙ}. Each dimension dᵢ represents a continuous range of preference strengths, where the largest positive value is a strong preference towards the positive trait (e.g., luxury for the dimension of cost), 0 is neutral, and the most negative value is a strong preference towards the opposite trait (e.g., budget). Here, positive and negative provide no moral connotations, but are just arbitrary assignments of preference directions. An individual user u's preference profile can be construed as:

$${d}^{u} = \{ {d}_{1}^{u} , {d}_{2}^{u} , … {d}_{n}^{u} \}$$

Further, assume that the LLM response of user u can be given by:

o=M(x,steer(d^{u}))

The generalized function M(⋅) represents the LLM's inference process, steer (⋅) represents the steering method that uses dᵤ to modify the activations during inference, and x represents the user's input to the LLM. The steering process described is h_{steered}←h+d^{u}·v, where h represents the intermediate representations at the residual stream of the LLM, v={v1, v2, . . . vn} are the steering vectors associated with different preference dimensions. Here, steering vectors represent desirable concepts or traits that the LLM is encouraged to align with. By injecting them into the residual stream during inference, alongside the strength of steering represented by dᵤ, the LLM's outputs are modified, changed or steered in the direction of the concept, effectively provisioning ‘control’ over the behavior of the LLM. Steering strength can be negative to induce compliance to the opposite behavior.

In various implementations, steering vectors are typically computed by contrasting the intermediate LLM activations of a dataset representing the desirable (positive) concept from a dataset of the opposite (negative) concept. The computation of the steering vector may be performed by training layer-wise linear probes that can accurately separate the representations of the positive and negative examples. The coefficients of the probe (a logistic regressor) are taken as the linear steering direction vᵢ, which can then be applied to amplify, dampen, or negate the concept in the LLM's internal representations with the steering strength di. Also, the subsequent parameter selection process outlined by “von Rütte et al.,” including choosing the top-k layers, may be utilized to modify the activations of (where the k layers are selected based on the accuracy of the probe for the layer).

In various implementations, process 600 may involve techniques to perform learning underlying user preferences. An algorithmic approach for learning the underlying preferences (the preference steering strength) of a user may be implemented based on the sentiment of their messages to the LLM. This approach forms the basis of the learn design interface, which is one of three steerable chatbots. To match an LLM's output preferences to the hidden preferences of a user, a technique is proposed for the LLM to learn and store an estimation of the user's preferences, denoted as:

$${d}_{i}^{u *} , where {d}_{i}^{u} \approx {d}_{i}^{u *}$$

The objective is to produce an output:

$${o}^{*} = M ( x , steer ( {d}_{u}^{*} ) )$$

that aligns with the user's desired output o. The LLM updates its estimation of the user's preference,

$${d}_{u}^{*} ,$$

through an iterative learning process based on feedback from user interactions. At timestep t, the update step for one dimension is:

$${d}_{t + 1}^{u *} ← {d}_{t}^{u *} + p ( dissatisfaction ( {x}_{t} ) \cdot direction ( {x}_{t} ) )$$

Here, xₜ is the user's message at round t of the conversation, dissatisfaction (⋅) measures the granular sentiment of dissatisfaction in the user's feedback, direction (⋅) is a binary classification that determines whether the user wants the model's outputs to shift positively or negatively, and p(⋅) is a simple linear transformation. While there are many specific design choices for these computations, the aptitude of the high-level methodology may be demonstrated using straightforward choices: (A) dissatisfaction (⋅) is taken as the weighted prediction probability from the pre-trained sentiment classifier “TweetEval” for both the negative and neutral sentiments; (B) direction(⋅) is determined based on the greater cosine similarity to embeddings of reference phrases (e.g., “I want more luxury” and “I want lower cost” for cost); (C) p(⋅) is a remapping of the estimated preference value to the functional steering range of the model.

In various implementations, process 600 may involve LLM personalization to align with desirable behaviors, and to customize content. Zero- or few-shot LLMs can perform reasonably well in personalized recommendations based solely on prompt inputs. RAG enables memory of prior user utterances through storing and retrieving the user's profile whenever preferences are relevant. Other techniques like fine-tuning and RLHF-based methods rely on modifying the weights of the LLM for better precision to the individual, but they demand more data and computation. Similarly, individualized or combinations of reward models or merging the outputs of multiple LLMs improved for different behaviors can align LLMs towards combinations of preferences. Conceptually, this is similar to applying steering, but steering vectors can be captured with no additional training, involving the LLM activations of a small dataset of texts. On the user-centered side, personalization also focuses on augmenting interaction features to allow users to specify their intentions better, such as through decomposing LLM outputs into subtasks, structuring the design dimensions of creative generation tasks, interactively asking for clarifications for underspecified prompts, and guiding users to learn condition-driven prompting. The solution is focused on exposing a linear steering factor for fine-grained control over personalization with open-ended brainstorming and recommendations in multi-turn, natural language conversations. Overall, steering can be applied to personalization through amplifying expressed preferences in pre-defined interpretable preference dimensions, expecting no prior history from the user. It works well in back-and-forth conversations, where users can specify additional requirements on top of the underlying modified or steered preference.

At operation 602, a preference associated with a prompt may be identified. In various implementations, the preference may include multiple features. For example, a user may provide a prompt such as “Plan a weekend getaway,” and the system may identify a preference such as cost. In this scenario, the cost preference may include a first feature corresponding to low-cost and a second feature corresponding to high-cost, representing opposing ends of the cost preference.

In various implementations, the preference may be received using one or more interface designs via which activation steering may be performed. One such manner of receiving the preference refers to a select mode. In the select mode, the AI model 122 generates one or more candidate preferences associated with a prompt. In some implementations, as the prompt is entered or after receiving the prompt, the AI model 122 determines the candidate preferences based on the prompt. The candidate preferences are presented on the user interface as selectable controls. When one or more of the candidate preferences are selected, as detected via selection of the corresponding controls, the selected candidate preferences are identified as the preference.

Each identified preference is associated with corresponding first and second features, which represent opposing ends of the preference. Each identified preference is further associated with a corresponding continuum defined between the first feature and the second feature. The continuum may be presented on the user interface as a user interface element, such as a slider, dial, knob, dropdown menu, toggle, input field, or other selectable interface element, to receive input indicating a strength of bias toward one of the features.

Another way of receiving the preference refers to calibrate mode. In the calibrate mode, the AI model 122 generates one or more candidate responses to the prompt. In some implementations, as the prompt is being entered or subsequent to receiving the prompt, the AI model 122 determines the candidate responses based on the prompt. The candidate responses are presented on the user interface as selectable components, such as radio buttons, selectable options, or other interface elements, wherein each candidate response is distinct from the others. When a candidate response is selected, as detected via selection of the corresponding selectable component, the selected candidate response is identified as the preference. For example, when a first candidate response (e.g., Response A) is selected, the first candidate response is identified as the preference, or when a second candidate response (e.g., Response B) is selected, the second candidate response is identified as the preference.

Each of the candidate responses corresponds to a different expression or version of the preference associated with the alternative features. In various implementations, the candidate responses reflect different tendencies toward the alternative features defining opposing ends of the preference.

In various implementations, for each of the candidate responses, either before or after selection, the user interface presents selectable user interface options corresponding to different strengths of bias of the respective candidate responses. That is, first options corresponding to the first candidate response are presented on the user interface and second options corresponding to the second candidate response are presented on the user interface. Each of the first options corresponds to a respective strength of bias toward the first candidate response, and each of the second options corresponds to a respective strength of bias toward the second candidate response. The selectable options enable the user to indicate not only a response but also a strength of bias of preference between the candidate responses. When a selection of an option is received as input from the first options or the second options, the selected option indicates a strength of bias corresponding to one of the first strength or the second strength. The selected option indicates the strength of bias, based on which a position on the continuum defined between the alternative features is determined. The determined position corresponds to a strength of bias toward one of the alternative features and is used to steer generation of subsequent responses.

For example, when the preference corresponds to a level of detail, the alternative features may include a simplified explanation as a first feature and a detailed explanation as a second feature. A first candidate response may provide a brief and high-level explanation, while a second candidate response may provide a more comprehensive and detailed explanation. The user interface may present selectable options such as “Strong A,” “Slight A,” “Same,” “Slight B,” and “Strong B,” where selection of “Strong A” indicates a strong bias toward the simplified explanation, and selection of “Strong B” indicates a strong bias toward the detailed explanation. Based on the selected option, the system determines a position along the continuum between the simplified and detailed features, which is then used to steer generation of subsequent responses.

Another way of receiving the preference refers to a learning mode. In the learning mode, in various implementations, the preference is determined based on a sequence of interactions with responses received from the model. In the learning mode, the system analyzes conversational inputs, feedback, or follow-up prompts received via the user interface to infer a preference associated with the prompt. The preference is identified based on patterns in the interactions indicating a tendency toward one of the alternative features associated with the preference. For example, when a prompt relates to restaurant recommendations, initial responses may be generated without a strong bias. Subsequent interactions, such as the user indicating “I prefer quick and simple options” or “something more refined,” are processed to infer a preference corresponding to a level of detail or ambiance. Based on such interactions, the system identifies the preference and associates the preference with a first feature and a second feature representing opposing ends. In some implementations, the sequence of interactions is further used to determine and refine a strength of bias, wherein each interaction contributes to updating a prior determination. The system iteratively adjusts the inferred preference and corresponding strength of bias based on the sequence of interactions, thereby enabling dynamic identification and refinement of the preference.

At operation 604, a position within a range (or a position on a continuum) defined using the first feature and the second feature may be determined based on the input received via the user interface. In various implementations, the position corresponds to the strength of bias toward one of the alternative features associated with the preference. In the select mode, the input may include a selection received via the user interface element corresponding to the continuum. For example, when the preference corresponds to cost, the user may position a slider to indicate a strength of bias of approximately 80% toward low-cost, thereby determining a corresponding position (position of the slider) on the continuum. In the calibrate mode, the input may include a selection of an option corresponding to a strength of bias between candidate responses. For example, selection of an option such as “Strong A” may indicate a strong bias toward one alternative, based on which a corresponding position (selection of the option) on the continuum is determined. In the learn mode, the input may include a sequence of interactions with responses received from the model. The system processes interactions to infer a bias and iteratively adjusts a prior position on the continuum to determine an updated position. The determined position reflects both a direction and magnitude of bias toward one of the alternative features.

At operation 606, the position within the range (i.e., the position on the continuum) may be provided to the AI model 122 to modify or steer generation of a response to the prompt based on the position. In various implementations, the position corresponds to a steering parameter representing the strength of bias, which is provided to the AI model 122 during inference. For example, in the select mode, a position corresponding to 80% toward low-cost may be provided to the AI model 122, causing the model to emphasize budget-friendly recommendations. In the calibrate mode, a position derived from a selection such as “Strong A” (favoring a simplified response) may be provided to the AI model 122 to bias generation toward concise outputs. In the learn mode, a position inferred from interactions such as repeated preference for budget-friendly or simple options may be provided to the AI model 122 and updated over time. In each case, the steering parameter influences internal representations of the model such that the generated response reflects the determined strength of bias.

At operation 608, a response to the prompt may be received from the model. In various implementations, the response is generated by the model based on the prompt and the applied position on the continuum.

At operation 610, display of the response in the user interface may be initiated. In various implementations, the response is presented on the user interface and may include indications of the applied preference or strength of bias.

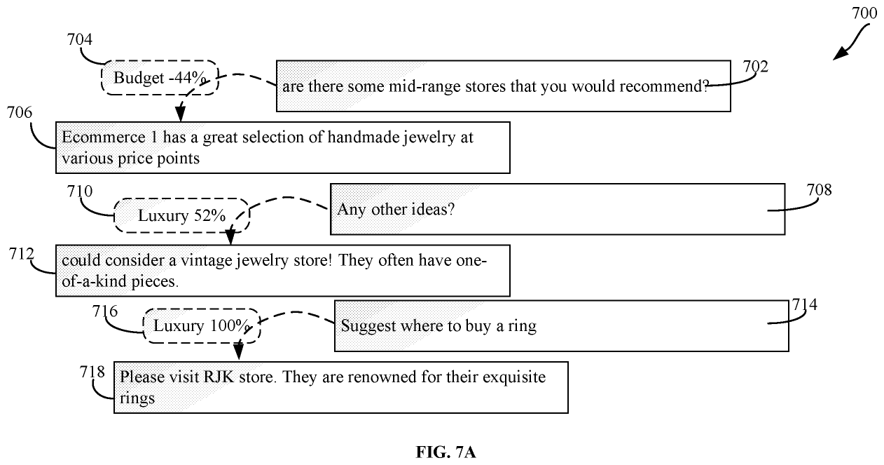

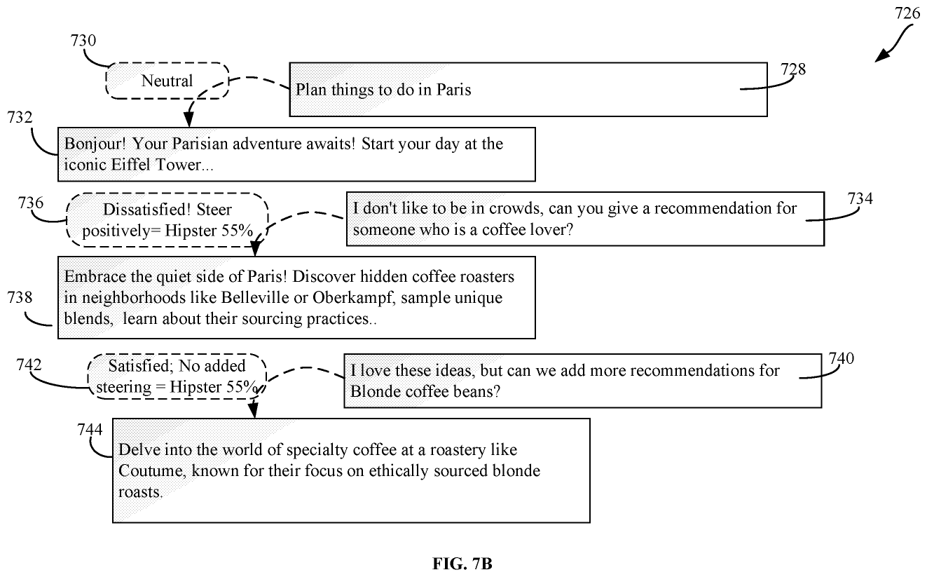

FIG. 7A illustrates an example conversational interaction for a gift shopping task 700 in which a strength of bias associated with a cost preference is dynamically adjusted across multiple conversational turns using a select aspect implemented via a select interface design. In this example, the cost preference is represented along a continuum between budget-oriented and luxury-oriented options as opposing features. During the interaction, the strength of bias at each step is adjusted or updated based on user interactions and prompts, and each adjusted/updated strength of bias corresponds to a position on the continuum of the cost preference.

For example, in response to a prompt 702, a strength of bias represented by “Budget −44%” 704 is set toward the budget-oriented end that results in generation of a response 706 that emphasizes affordable or mid-range options. Subsequently, the strength of bias is adjusted toward the luxury-oriented end 710 in response to a subsequent prompt 708. The adjusted strength of bias results in generation of a subsequent response 712 that reflects more premium or distinctive recommendations. At a later stage, the strength of bias is further increased toward the luxury-oriented end 716 in response to prompt 714, resulting in a response 718 that emphasizes high-end or designer options.

In each step, the conversational generative AI model applies the selected strength of bias to generate responses aligned with the indicated preference. As shown, changes in the strength of bias across turns result in corresponding changes in the generated recommendations, including shifts in both direction and magnitude along the continuum. In this manner, FIG. 7A demonstrates real-time, user-controlled personalization of responses through application of strengths of bias, without requiring prompt-based conditioning or modification of model parameters.

FIG. 7B illustrates an example conversational interaction for a travel planning task 726 in which a strength of bias associated with an ambiance preference is determined and updated using a learning modality. In this example, the preference is represented along a continuum between mainstream or tourist-oriented options and niche or non-touristy options (e.g., hipster-oriented options) as opposing features.

The interaction begins with a neutral prompt 728, resulting in a response 732 that reflects a neutral strength of bias 730. Next, in response to a user message 734 expressing a negative sentiment toward crowded or tourist-heavy environments, the system determines a direction of bias toward non-touristy or hipster-oriented options and determines the corresponding strength of bias 736. The determined strength of bias is applied to generate a response 738 that emphasizes less crowded. In a subsequent interaction, the user expresses a positive sentiment 740 reinforcing the previously suggested direction of bias. Based on this interaction, the strength of bias 742 is maintained or adjusted while remaining directed toward the hipster-oriented end of the continuum. The conversational generative AI model then generates a response 744 aligned with the maintained strength of bias, providing recommendations consistent with the inferred preference.

In this manner, FIG. 7B demonstrates determination and dynamic updating of the strength of bias based on sentiment and intent expressed in user interactions, and application of the strength of bias during inference to generate personalized responses without requiring explicit user selection or modification of model parameters.

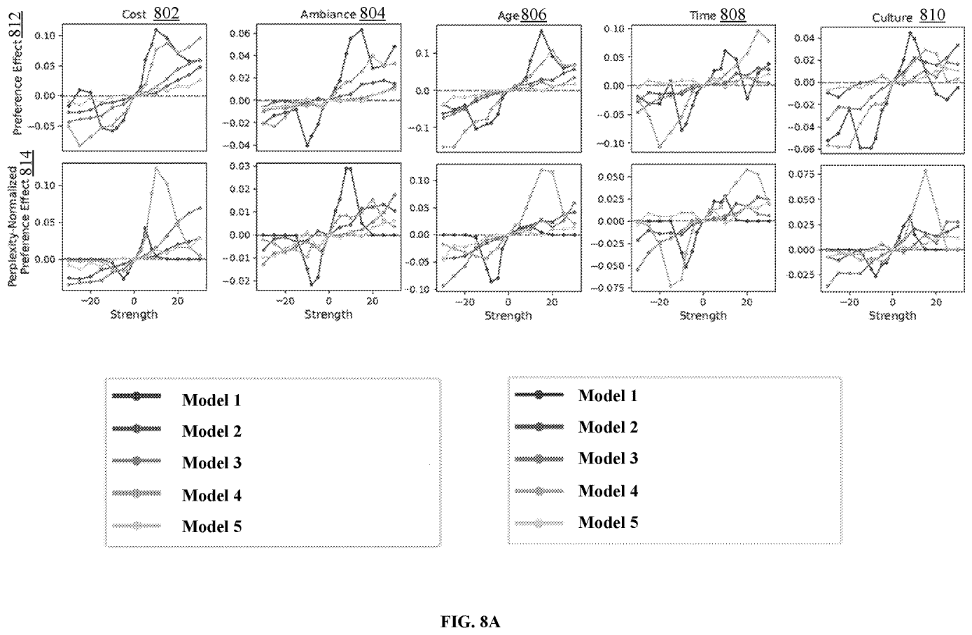

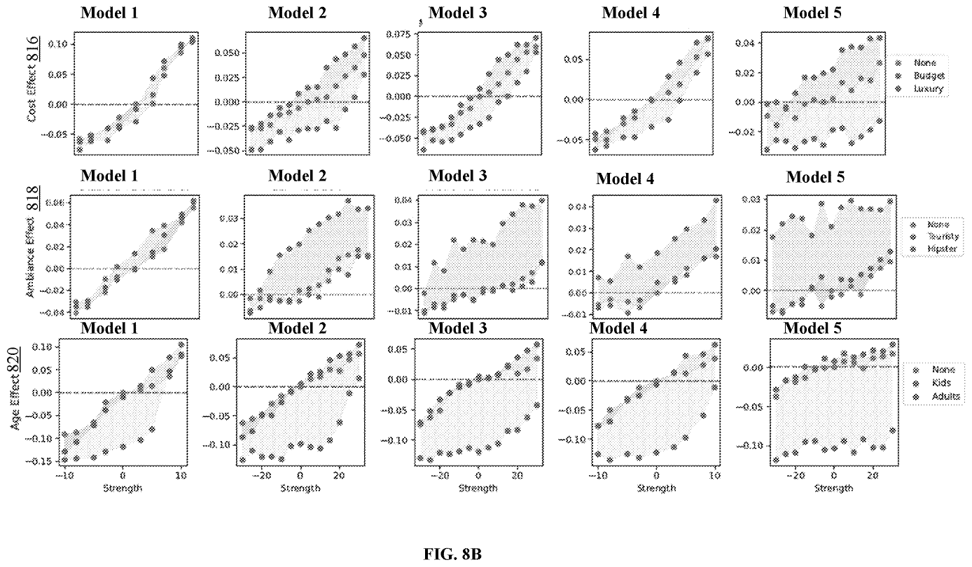

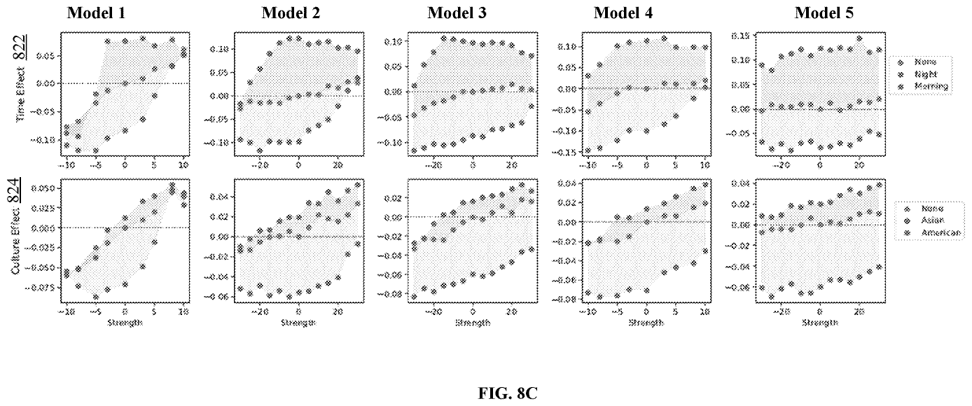

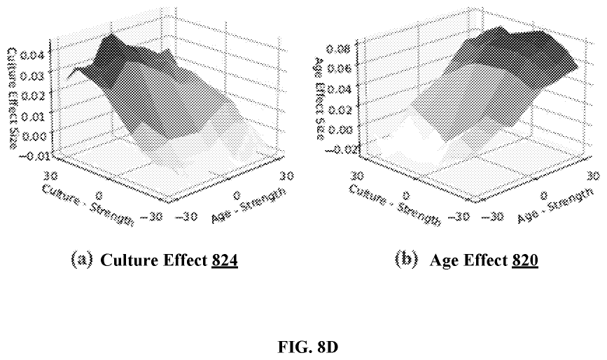

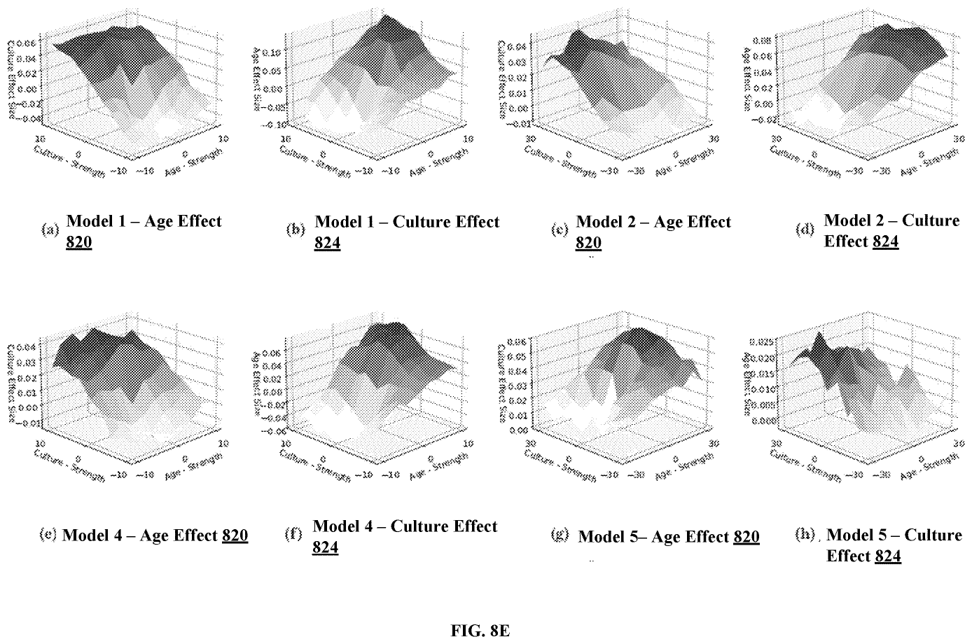

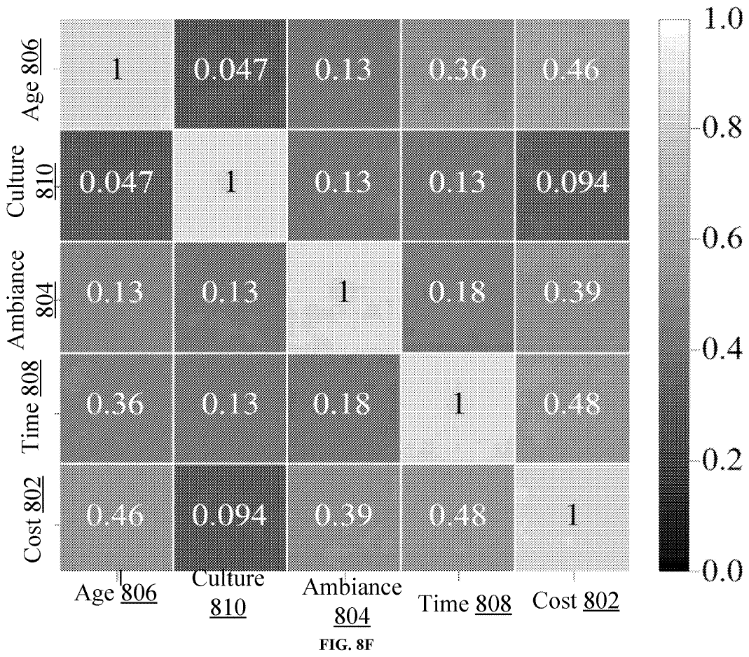

FIG. 8A through FIG. 8E illustrate the effect of expressed preferences and perplexity-normalized effect for all preferences and models. FIG. 8A shows the effect of expressed preferences (top) and perplexity-normalized effect (bottom) for all preferences (e.g., cost 802, ambiance 804, age 806, time 808, and culture 810) and models. In various implementations, the computational examples provide the proof-of-concept for an activation steering framework for LLM personalization. A series of computational experiments are conducted that demonstrate the effects of steering on preference-based personalization in various usage scenarios. In this section, task and preference dimensions (i.e., preference), evaluation of metrics, implementation details, and the set of experiments and their results are described. For generalizability across different LLM architectures, the same steering procedure may be applied to five open-source LLM models ordered in increasing size, such as, for example, model 1, model 2, model 3, model 4, and model 5. Due to the nature of the method, the model's intermediate activations may be directly accessible. In various implementations, the parameters or hyperparameters of all models are fixed with a temperature of value 0.7 (temperature=0.7), with top_k value of 50 (top_k=50) and top_p of value 95 (top_p=0.95) to encourage some diversity through sampling. A constraint of a maximum of new tokens of 100 (max_new_tokens=100) may be used to restrict the length of the output.

In various implementations, task and preference dimensions may be set. In selecting the application domain, everyday tasks may be identified that AI assistants can help with, a) having high variability given differences in individual preferences, and b) being open-ended and generative in nature. Based on these criteria, consider the domain of lifestyle planning. To build a realistic query dataset, n=30 real user questions may be processed, encompassing topics like travel planning, restaurant recommendations, recipe selection, and gift shopping. Questions that appeared at the start of an interaction and that were open-ended and not grounded in particular preferences or specifications may be filtered. For example, “What are the best restaurants in San Francisco?” Below shows a sample of real user queries selected from the dataset in the domain of lifestyle planning that were used throughout the computational experiments.

### Table-A Shows Sample Task Queries Used in the Computational Examples.

| | |
|---|---|
| 1 | Give a recipe idea for a vegetarian meal which has tofu? |
| 2 | What are some popular souvenirs people take home when they visit the USA from Europe? |
| 3 | What are the best restaurants in San Francisco? |
| 4 | Hi, I am trying to plan a camping holiday with my family. What supplies do you suggest I |
| | purchase or pack? |
| 5 | I want to buy a gift for my friend for Valentine's Day |
| 6 | What are some things I should do on a 5-day vacation in Thailand? |
| 7 | What is the best way to cook a tomato? |

Derived from this task domain, five specific preference dimensions are described in Table B—cost, ambiance, age, time, and culture. Table B shows a list of preferences and their respective negative and positive steering traits. The effect of the expressed preference is evaluated based on cosine similarity to a corpus of example PQR website reviews, the processing details of which are provided. The opening queries of user study tasks that correspond to the applicable preference dimensions are also listed.

Table B Shows a List of Preferences and their Respective Negative and Positive Steering Traits

| | | | PQR dataset processing | |
|---|---|---|---|---|
| Preference | Negative | Positive | details | User study opening query |
| Cost | Budget | Luxury | Price point of 1 (budget) | Help choose a present for a |
| | | | vs 4 (luxury) | friend who likes earrings |
| Ambiance | Touristy | Hipster | Ambiance of touristy vs | Plan things to do on a |
| | | | hipster | vacation to Paris |
| Age | Kids | Adults | Attribute of kids-friendly | Suggest some meal prep |
| | | | being True vs False | recipes |
| Time | Evening | Morning | Business hours in the | N/A |
| | | | evenings vs morning | |
| Culture | Asian | American | Keywords related to | Give me some date night |
| | | | Asian vs American food | restaurants in San Francisco |

Each dimension may have bi-directional traits (e.g., luxury and budget for the dimension of cost), which corresponds with the positive and negative directions of the steering vector. In other words, to steer an LLM towards budget preferences, inject the cost steering vector v_{cost} with a negative strength factor d_{cost}<0 into the LLM's residual stream while it processes an input user query. In some implementations, the bi-directionality may represent the absence of presence of a trait, i.e., where the bias runs from zero to 100, for example. In various implementations, expressed preferences may be evaluated. The evaluation of the amount of expressed preference in the LLM's outputs using real-world human-written data. For each preference trait, a corpus of reviews may be extracted that embody the trait based on the criteria described in Table A. Each corpus is filtered for quality, leaving between 700-900 reviews per trait to create a reference dataset. Below Table C shows a reference dataset.

### Table C Shows Sample PQR Reviews of the Traits Touristy and Hipster for the Ambiance Dimension

1. [PQR reviews for hipster]
2. There are restaurants, bars, and cafes in some cities that you go to because they are enough
to stand out from anything in their category
3. This is a place I would highly recommend if you are looking for somewhere different to
eat that does not have the usual bar fare.
4. I wish I wasn't reviewing this place because I want it to remain a hidden gem. This is by
far my favorite restaurant in this location A.
5. This is a great find just outside of the hustle and bustle of downtown...
6. The B's Lounge hosts great bands and events, including local acts, and sports pin-up gals
on the bar.
7. Amazingly friendly staff. Building is just bursting with personality.
8. Simply lovely. Every dish had an unusual but delicious mix of flavors and textures.
9.
10. [PQR reviews for touristy]
11. The signature iced tea was fabulous! There was a long wait but worth every minute of
it!
12. Reading Terminal Market has everything that you request; everything is fresh, good, or
good for you
13. The highlight of the cruise was the tour guide/narrator Charles and his eloquent oration.
14. We were so excited to visit here from Las Vegas. What a Christmas event for us!!!
15. Love coming here :) so many goodies. It is bustling, so if you're one who doesn't like
waiting in lines, you'll have to suck it up!
16. You can find anything you want, and the atmosphere is great for tourists and newcomers.
If touristy is what you want, they serve great cheesesteaks!
17. E's vibe was touristy (we were tourists as well haha) but crowded and people were
talking to order off a simple menu.

PQR may be one of the existing websites, and its reviews are found to be viable as they reflect genuine traces of human preferences, contain relevant metadata to filter for the preferences, and are closely related to the domain of lifestyle tasks. The effect of expressed preference is the relative cosine similarity between the LLM output's embeddings and each of the bidirectional traits' reference PQR review dataset. Effect=cos(eₒ, ē₊)−cos(eₒ, ē), where eₒ is the embeddings of the LLM's output, ē₊ is the mean embeddings of the positive trait's reference dataset, and ē₋ is that of the negative trait's reference dataset. The embeddings are computed using a pretrained model, which captures sentence-level semantics appropriate for lengthy reviews and outputs. A positive relative cosine similarity means closer alignment to the positive steering trait, and vice versa for the negative steering trait. Similarity scores, rather than hard classification, allow us to capture more nuanced intensities of preference expressions.

In various implementations, as the magnitude of steering increases, a degeneracy in the quality of the LLM's output is observed. To evaluate this, the perplexity-normalized effect (PNE) 814, which incorporates a measure of how the model's perplexity, a proxy for degeneration, changes with steering compared to a non-steered baseline, is used. This equation is:

(Effect_{steer=d}−Effectₛₜₑₑᵣ₌₀)/(PPL_{steer=d}/PPLₛₜₑₑᵣ₌₀)

PPL is perplexity and d is the steering strength. If perplexity increases disproportionately more than the preference effect, then the PNE 814 will be low, reflecting reduced quality.

In various implementations, some computation examples are utilized to answer different questions. The Personalization problem is used to focus on one preference dimension at a time as steering towards multiple preferences simultaneously has unpredictable effects. In some implementations, first, the effect of bi-directional, granular steering strengths on the LLM's outputs in comparison to un-steered responses is evaluated to see how steering strength affects the preferences expressed. Next, an evaluation is performed to evaluate how prompting interacts with steering. In conversations, users can inject personal preferences through prompts, so an investigation is carried out to see how this interacts with steering. Steering can also be thought of as aligning with the user's underlying preference profile, and prompting adds contextualized variability—for example, “I want to treat myself!” should yield different responses for luxury-seeking vs. budget-oriented users if the LLM is correctly primed with their preferences. Further, a computation is carried out to see whether multiple preferences are modified or steered. To demonstrate generalization beyond a singular dimension, an evaluation of the effects of steering when simultaneously steering towards two compounded preferences is performed. This is a preliminary step towards more complex steering scenarios with even more layered preferences. Furthermore, computation involves determining whether hidden preferences are learned. For determining that hidden preferences are learned, a prototype of how steering can be adaptively learned and applied in a conversation with a synthetic user, who has a hidden preference unknown to the model.

In various implementations, computation example results are evaluated. A steering between −30<d<30 at increments of 5 may be applied, and the mean preference effect 812 may be measured across the LLM's responses to the query dataset. The standard and PNE 814 for the models and preferences are shown in FIG. 8A. The values are standardized to center around d=0 as the neutral point with effect=0. Under ideal circumstances, a linear increase in preference expression corresponding to the increasing steering strength may be seen. In various examples, near-linear relationships between steering strength and PNE 814 may be observed within the functional steering range of the model. For models that are highly sensitive to steering, like Model 1 and Model 4, this range is smaller than for the other models (see Table-D). For ensuing experiments, steering may be performed within the functional range of the LLM to preserve quality. In summary, the steering, in controlled moderation, can effectively guide the preference expressed by LLMs. For selecting a probe type and the k hyperparameter for the top-k layers, where steering is selectively applied to the top-k of the layers with the key detection accuracy. Also, an approximate functional steering range is experimentally determined where the model is not affected significantly by degeneracy (high-perplexity responses). This functional range is used in computational examples and the user study. Table-D shows the steering parameters selected for each model.

### Table-D Showing the Steering Parameters Selected for Each Model

| | | Functional | |
|---|---|---|---|
| Model | Top K layers | steering range | Probe |
| Model 1 | 16 | (−10, 10) | Logistic |
| Model 2 | 16 | (−30, 30) | Logistic |
| Model 3 | 24 | (−30, 30) | Logistic |
| Model 4 | 24 | (−10, 10) | Logistic |
| Model 5 | 32 | (−30, 30) | Logistic |

In various implementations, the effect of prompting on steering is computed or determined. The same evaluation of the effect of bidirectional granular steering strength on the LLM's outputs in comparison to un-steered responses may be repeated in addition to preference-based prompts to each question in the query dataset. For each preference dimension, augment the queries with prompting for both the positive and negative traits, such as “I am morning-oriented and an early riser” for the morning trait and “I am evening-oriented and a night owl” for the night trait. The objective is to understand how steering and prompting interact, especially what happens to the expressed preferences if the directions contradict or reinforce each other. FIG. 8B and FIG. 8C show the offset induced in the preference effect as a result of adding preference-based prompts. In particular, FIG. 8B and FIG. 8C show the effect of additional prompting on steering for preferences: cost (with cost effect 816), ambiance (with ambiance effect 818), age (with age effect 820), time (with time effect 822), and culture (with culture effect 824). Red points represent prompting towards the positive trait and blue towards the negative trait. In various implementations, the sample Kolmogorov-Smirnov test may be utilized for significance (p<0.05); it is determined that for cost, only Model 2 is significantly affected by prompting. Furthermore, prompting kids has a significant effect in models, while prompting adults does not mean that some preferences are by default asymmetrical (likely because the average user prefers adult-oriented suggestions). Further, in particular, time is sensitive to prompt. The significance of these results, while variable across models, indicates that prompting can intensify or reduce the effect of preference expressions on top of steering. This may be considered as a practical trait for a steerable chatbot-steering to the user's underlying preference contextualizes the overall conversation, and adding prompting introduces variability within the context. See Table E for qualitative examples that demonstrate contextualized outputs. For this reason, Model 2 is used as the base model of the user study due to its sensitivity to prompting, which allows the model to respond to user prompts in addition to steering. For example, Table-E shows sample text output for Model 3 with cost dimension as qualitative results demonstrating how outputs can be contextualized to the “true” preferences of the user.

Table E Shows Samples of Steered Outputs from Model 3 with Preference-Based Prompting for Cost

| | | Prompt toward | Prompt towards |
|---|---|---|---|
| Cost preference | No prompting | Luxury | Budget |
| Model 3 (d = 0) | Here's a list of items | Here's a | Here's a list of |
| “Average user” | you might want to | comprehensive list of | camping supplies to |
| | consider for your | camping supplies for | help you get started |
| | camping trip. 1) Tent: | your family camping | while keeping it |
| | Depending on the | holiday. 1) Tent: A | budget-friendly. 1) |
| | size of your family, | spacious and high- | Tent: A 4-person |
| | you'll request a tent | quality tent is key. | dome tent is a |
| | that can comfortably | Consider a tent with | popular and |
| | accommodate | multiple rooms to | affordable choice . . . |
| | everyone . . . | provide privacy and | |
| | | separate areas for | |
| | | each family | |
| | | member . . . | |
| Model 3 (d = 20) | To ensure your | To ensure that your | To ensure a |
| “Wealthy user” | comfort and | stay is nothing less | comfortable and |
| | convenience, I have | than perfect, I have | enjoyable adventure, |
| | prepared a | prepared a | I have compiled a list |
| | comprehensive list of | meticulously curated | of items that will |
| | items. 1) Tent: A | list of the most | cater to your requests |
| | four-season, safari- | exquisite and | without exceeding |
| | style tent with a large | indulgent camping | your budget. 1) Tent: |
| | canopy . . . | supplies . . . | A spacious 4-person |
| | | | dome tent with a |
| | | | waterproof flysheet |
| | | | and a mesh canopy |
| | | | for stargazing . . . |
| Model 3 (d = −20) | Tent: Depending on | Here are some items | Here are some |
| “Budget user” | your camping style, | to consider when | budget-friendly |
| | you may request a | planning a camping | supplies for a |
| | tent. There are | trip: 1) Tent: There | camping holiday: 1) |
| | various types of tents | are various types of | Tent: Consider |
| | available, such as | tents available, from | buying used tents or |
| | dome tents, | simple pop-up tents | borrowing from |
| | backpacking tents, | to more complex | friends . . . |
| | and family tents . . . | backpacking tents . . . | |

In various implementations, steering towards multiple preferences is determined. As this is an exploration of multi-steering, two dimensions may be focused on instead of one. In future contexts, this should be extended to incorporate more preferences, ideally ones that are orthogonal to each other. Since the preferences are not inherently orthogonal, two dimensions with the least collinearity, which are culture and age (see correlation analysis in FIG. 8F) may be selected. In various implementations, FIG. 8F shows a correlation map of the cosine similarities between each of the preference dimensions (this is computed based on the mean of the PQR website reviews reference embeddings). The least correlated pair, age and culture, are selected for additional multi-preference steering result determination. Qualitative examples of multi-steered outputs from Model 3 are shown in Table-F.

TABLE F
Table-F shows samples from multi-preference steering
with preferences age and culture

| | Model 3 (d_{culture} = 30, | Model 3 (d_{culture} = −30, |
|---|---|---|
| | steer [symbol] American) | steer [symbol] Asian) |
| Model 3 | San Francisco is known for | San Francisco, being a vibrant |
| (d_{age} = 30, | its vibrant dining scene, | city with a rich culinary scene, |
| steer [symbol] | offering a wide range of | offers a wide array |
| Adults) | culinary events. | of exceptional restaurants |
| | Here are some of the top- | that cater to various |
| | rated restaurants in the city. | gastronomic preferences. 1) |
| | 1) The Slanted Door- | Izakaya Roku: Known for its |
| | Overlooking the Bay, this | authentic and vibrant izakaya |
| | restaurant offers | atmosphere, this |
| | breathtaking views | restaurant offers |
| | alongside a menu of | a comprehensive selection of |
| | contemporary American | Japanese small dishes |
| | dishes . . . | and sake . . . |
| Model 3 | San Francisco offers a | Here are some popular |
| (d_{age} = −30, | variety of family-friendly | restaurants that you can |
| steer [symbol] | restaurants that are popular | consider visiting. 1) |
| Kids) | among tourists and locals. | Cookie Factory: This is |
| | Here are some of the best | a fun and educational |
| | restaurants in the San | event where you can make |
| | Francisco Bay Area. 1) The | your own fortune cookies. |
| | Original Pancake House: A | It's |
| | roadside attraction featuring | a great way to introduce kids |
| | giant dinosaur statues and a | to different shapes and |
| | restaurant serving breakfast | designs . . . |
| | foods . . . | |

In various implementations, the steering strength may be varied and applied for each dimension uniformly and measure the effect of each preference separately. The steering vector is a weighted combination of the individual preference vectors. FIG. 8D shows three-dimensional (3D) surface plots of the variation of the preference effect for culture and age for Model 3. While the range of effects is slightly degraded at large values of complementary steering, the surfaces follow the expected trend. Surface plots for other models are in FIG. 8E. Qualitative samples of multi-steered texts for Model 3 are shown in Table-F, which highlights phrases that exemplify each of the target traits. The results of multi-preference steering suggest that multiple preferences can be steered additively, which is promising for scaling up steering as a personalization framework.

In various implementations, learning underlying preferences and steering may be performed. Lastly, the proposed preference learning algorithm may be evaluated in simulated user conversations, where LLM role-plays as the user with a hidden preference. This experiment acts as a precursor validation step before implementing “learn” for the user study. For ease of experimentation, learning underlying preferences and steering may be conducted with the preference of cost, setting the hidden preference values to extreme levels of dₕ=−100 (fully budget) and dₕ=100 (fully luxury). LLM may be prompted with in-context examples of what the user's preference at these levels and is instructed to output a response to the LLM's output with the 1) level of satisfaction that the user would feel, and 2) the direction of change (cheaper or more luxurious) that the user would want. In various implementations, the output of LLM may be appended with a new task question from the query dataset at every round, which effectively simulates a dynamic conversation with user feedback covering multiple topics. On the LLM side, it is first initialized with no steering, then the update step from the equation below:

$${d}_{t + 1}^{u *} ← {d}_{t}^{u *} + p ( dissatisfaction ( {x}_{t} ) \cdot direction ( {x}_{t} ) )$$

The above equation is applied to calculate the direction of the update, the step size being proportional to the dissatisfaction, to compute the preference effect of the LLM's generation for cost at each turn.

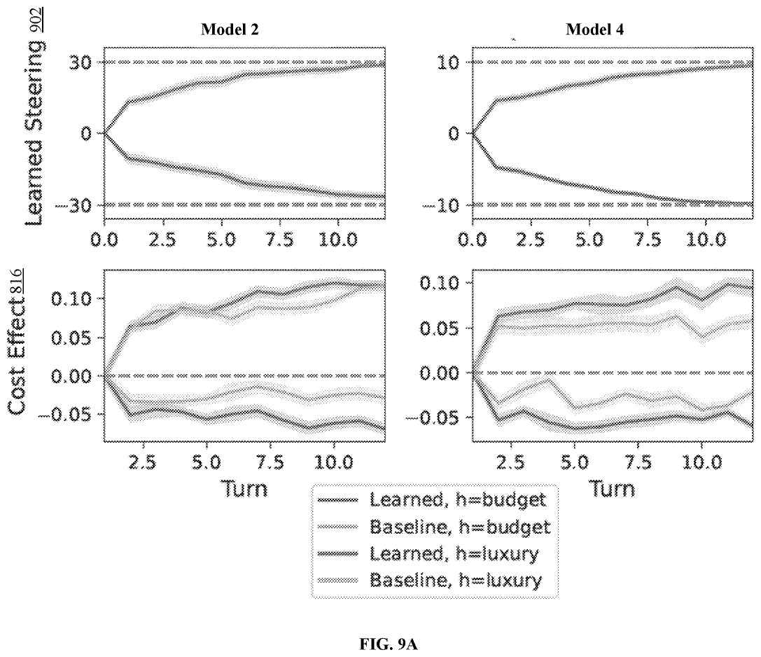

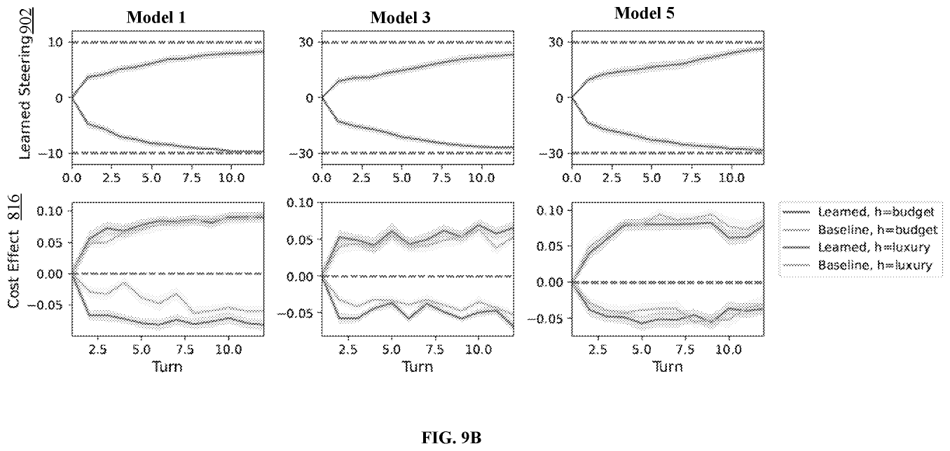

FIG. 9A shows the learned strength levels and preference effects for cost 802 for Model 2 and Model 4, where blue represents trials where the latent preference h is 100% budget, and red represents 100% luxury. Other models are in FIG. 9B, where blue represents trials where the latent preference h is budget, and red represents luxury. It is evident that the LLMS were able to converge towards the correct steering strengths given the hidden preference of the user and the model's own functional steering range. The effect of the model with learned steering 902 is compared to one without steering (baseline). The gaps between learned steering 902 and baseline of the models shown are significant by the Kolmogorov-Smirnov test (p<0.05), except for Model 2 with h=luxury. This shows that the learned steering improved the expression of preference compared to a prompt baseline. Both the Learned and Baseline versions of the models receive feedback from the user model and have access to the conversation history, which means that even the un-steered model can adjust its outputs to reflect the prompts of the user. In some cases, the models were significantly affected by prompting, e.g., Model 5, which would be more adaptive through prompting alone, which is reflected in a lack of significance between Learned and Baseline (see FIG. 9B). Nevertheless, the learned steering approach demonstrates potential to dynamically adjust steering based on the sentiment of user feedback. This allows for lightweight inference time personalization and is especially applicable to cold-start scenarios.

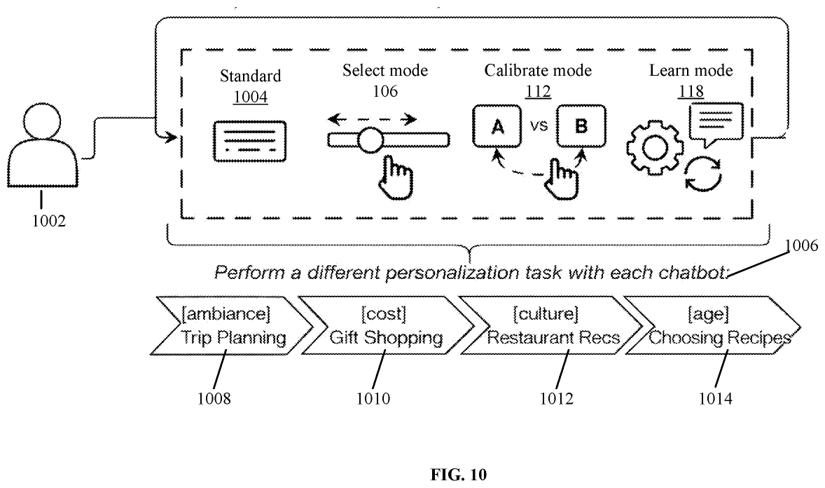

FIG. 10 illustrates examples of personalization tasks implemented using a standard interface 1004 and the interfaces provided by the present technical solution of this disclosure. In various implementations, the effectiveness of activation steering, its interaction with prompting, and the feasibility of learning latent preferences are evaluated. The interaction of users 1002 with steerable chatbots and the impact of steering on real conversational scenarios are further analyzed. Because the steering parameter is a linear and interpretable value, different interface designs for controlling steering are evaluated. The strength of bias is exposed to users 1002 through three interface designs: (i) SELECT (implementing select mode 106), which enables direct manipulation of steering; (ii) CALIBRATE (implementing calibrate mode 112), which determines a strength of bias based on calibration inputs; and (iii) LEARN (implementing learn mode 118), which adjusts the strength of bias based on sentiment expressed during conversation. The evaluation includes both quantitative and qualitative evaluation. A within-subjects study design is employed in which participants/users 1002 interact with three steering interface designs, as well as a baseline PROMPT-based chatbot without steering (i.e., standard interface 1004). A high-level procedure of the study is illustrated in FIG. 10. Prior to initiating tasks, participants provide self-rated preferences for each task and associated dimensions on a scale of 1 to 10, where lower values correspond to one end of a preference and higher values correspond to an opposing end. The preference values are converted to a −100 to 100 scale for analysis. Participants also provide demographic information, including age, gender, and baseline usage of large language models. Each participant completes a distinct personalization task 1006 using each interface. The baseline interface (standard interface 1004) is presented first to establish familiarity with the chatbot and task, while the order of the remaining interfaces is randomized. Task-to-interface assignments are counterbalanced to reduce task-dependent bias. Interfaces are anonymized and presented as A, B, C, and D to avoid bias in evaluation. The tasks correspond to predefined preference dimensions, including gift shopping 1010 (cost), vacation/trip planning 1008 (ambiance), restaurant recommendations 1012 (culture), and meal preparation/choose recipes 1014 (age suitability). Each task is initiated using a predefined query to ensure consistency across trials. Following the initial response, participants may provide follow-up inputs to refine outputs or adjust preference direction. Interactions continue for multiple turns until satisfactory responses are obtained or a time threshold is reached. Upon completion of the tasks, participants provide subjective evaluations using a 7-point bipolar Likert scale for each interface. The evaluation criteria include likelihood of use, satisfaction with personalization, perceived control over personalization, and perceived persistence of preferences across interactions.

In various implementations, the strength of bias is represented within a standardized range from −100 to 100, corresponding to values presented to users via the user interface. The standardized range may be mapped to an effective steering range of the underlying AI model during application. FIG. 2, FIG. 3A, FIG. 3B, and FIG. 4 illustrate example interface configurations and corresponding operational differences across modalities.

In a PROMPT (standard interface 1004) modality, a baseline interface is provided without activation steering, such that personalization of the AI model is controlled through user-provided prompts.

In a SELECT (select mode 106) modality, the strength of bias is controlled via a slider positioned within the user interface. The slider spans a range from −100 to 100 to provide an interpretable representation of the strength of bias, and the selected value is mapped to the effective steering range of the AI model during inference. The selected strength of bias is applied dynamically, enabling adjustment throughout the conversation. In a CALIBRATE (calibrate mode 112) modality, a calibration process is performed prior to or during interaction with the chatbot interface to determine an initial strength of bias associated with a preference. During calibration, pairwise outputs (Response A and B) for pre-written calibration questions are generated by sampling two different steering strengths, which are initially set with disparate values of d_{A}=−100 and d_{B}=100. Based on the user's response, the steering strengths are updated to be closer to the steering strength. For example, updating d_{A}←(d_{A}+d_{B})/2 to be closer to d_{B} if the preference is Slightly B. This calibration step is repeated 2-3 times until rough convergence, when A and B are similar. The final steering strength d is computed as the average of d_{A} and d_{B}.

In a LEARN modality (learn mode 118), similar to a baseline interface, personalization is influenced through user-provided prompts without explicit selection via user interface controls (FIG. 4). The strength of bias is determined and updated based on analysis of user interactions, including sentiment and intent expressed in a most recent message, and a corresponding direction of preference. For example, a user input indicating dissatisfaction with previously generated options and a preference for more affordable alternatives results in determination of a direction of bias toward a budget-oriented feature and an updated strength of bias corresponding to that direction. In some implementations, the determined strength of bias is presented along with generated outputs, such as in a percentage-based representation (e.g., “35% budget”), thereby providing transparency regarding how the preference influences generation of responses.

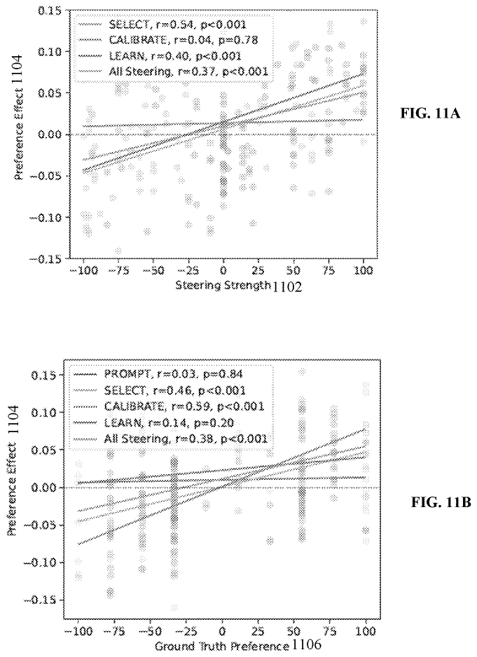

FIG. 11A shows correlation between the applied steering strength 1102 and the effect of the preference expressed 1104 in the LLM's output. It depicts the correlation for each steerable chatbot separately, as well as three aggregated together, where each data point is the preference effect (relative cosine similarity to the positive/negative traits) of a single message sent by the LLM. Pearson correlation analysis shows that SELECT (r=0.54, p<0.001) and LEARN (r=0.40, p<0.001) both demonstrate significant positive relationships between the steering strengths and the expressed preference, matching the results from the computational experiments. The CALIBRATE has a result (r=0.04, p=0.78). Overall, three steerable chatbots combined reached significance (r=0.37, p<0.001). Steering is effective at controlling the expressed preference when the user is relatively satisfied with the personalization. When the user is not satisfied, prompting opposing preferences can still be effective at retaining control over the conversation.

In various implementations, alignment with underlying user preferences may be accomplished. After establishing that steering can guide preference expressions in real-world conversations, the natural follow-up is to understand if the steering actually matches people's underlying preferences. The correlation between the participant's self-recorded ground truth preferences 1106 and the preference effect 1104 expressed by the LLM per message in FIG. 11B. Pearson correlation analysis shows that SELECT (r=0.46, p<0.001) and CALIBRATE (r=0.59, p<0.001) have correlations—that the preferences expressed by the LLM in conversation correspond moderately well with the true preferences of the user. LEARN has a result of (r=0.14, p=0.20), and PROMPT has a result (r=0.03, p=0.84). Overall, steerable chatbots combined shows show significant improvement in generating relevant preference content than the baseline (r=0.38, p<0.001).

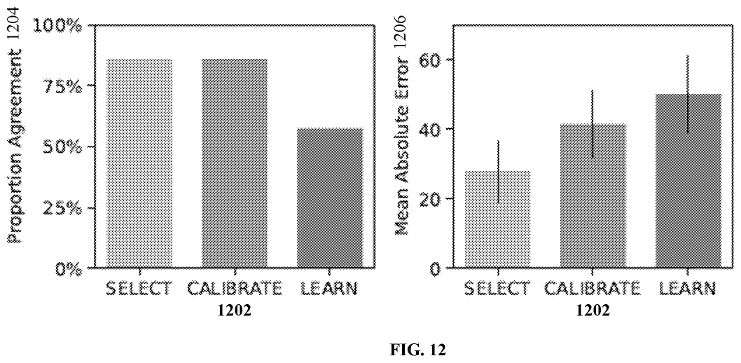

FIG. 12 illustrates data of each steerable chatbot matched to the user's preference (left) with proportion agreement of preferences 1204 and mean error 1206 of the steering strengths (right). This figure compares the chatbots 1202 across two measures, for example, do the steering strengths directly agree with ground truth preferences (e.g. is the steering value positive if the user indicates they prefer luxury for cost?); and what is the error between the steering value and ground truth for the given task and preference? SELECT had the lowest mean error (27.8±31.9) and highest proportion of agreement at 86%. CALIBRATE was able to match the agreement rate but had higher errors (41.4±34.6). LEARN was less robust and achieved slightly above random rate of agreement at 57% and highest error (50.1±40.9).

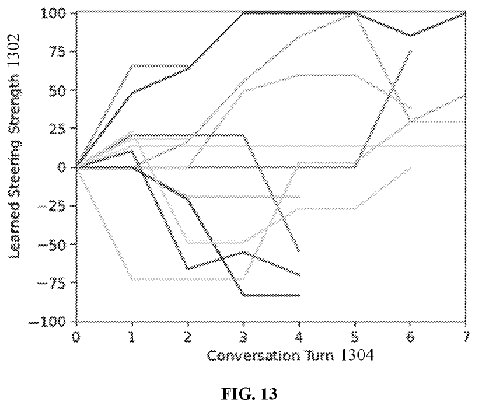

FIG. 13 shows the progression of the learned steering strengths 1302 across participant conversations 1304, with red indicating more positive strengths and blue indicating more negative. In combination with the correlation analysis results. This suggests that if the steering factor is relatively accurate, the chatbot's expressed preferences can align well with users' hidden preferences.

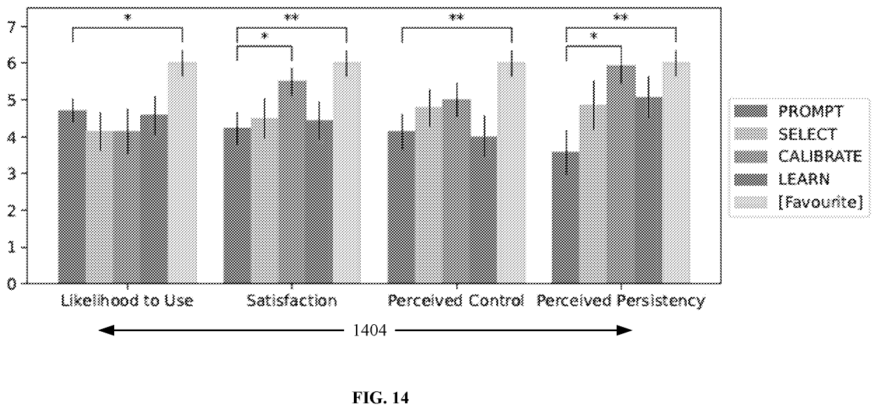

FIG. 14 illustrates perceptions results 1404 for four interfaces. Due to high heterogeneity in the participants' interfaces, differences are computed based on each participant's interface. Statistically significant differences with respect to prompt are indicated with * (p<0.05) or ** (p<0.005).

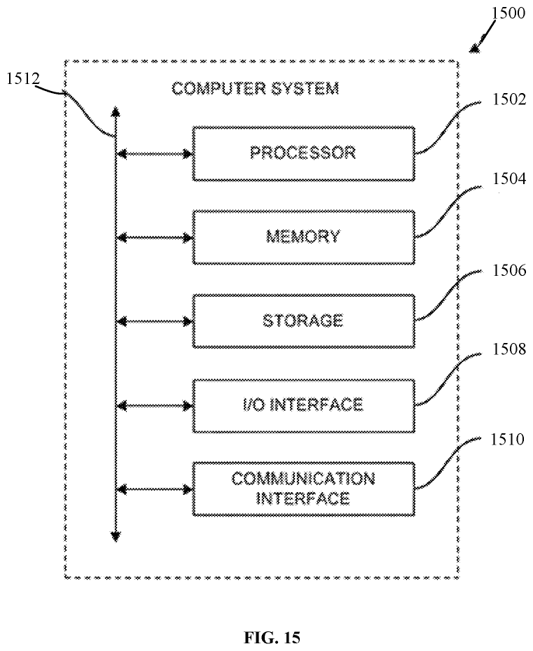

FIG. 15 illustrates an example of one or more computer systems 1500. In particular implementations, one or more computer systems 1500 perform one or more steps of one or more methods described or illustrated herein. In particular implementations, one or more computer systems 1500 provide functionality described or illustrated herein. In particular implementations, software running on one or more computer systems 1500 performs one or more steps of one or more methods described or illustrated herein or provides functionality described or illustrated herein. Particular implementations include one or more portions of one or more computer systems 1500. Herein, reference to a computer system may encompass a computing device, and vice versa, where appropriate. Moreover, reference to a computer system may encompass one or more computer systems, where appropriate.

This disclosure contemplates any suitable number of computer systems 1500. This disclosure contemplates computer systems 1500 taking any suitable physical form. As an example and not by way of limitation, computer systems 1500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer systems 1500 may include one or more computer systems 1500; be unitary or distributed; span multiple locations; span multiple machines; span multiple data centers; or reside in a cloud, which may include one or more cloud components in one or more networks. Where appropriate, one or more computer systems 1500 may perform without substantial spatial or temporal limitation one or more steps of one or more methods described or illustrated herein. As an example, and not by way of limitation, one or more computer systems 1500 may perform in real time or in batch mode one or more steps of one or more methods described or illustrated herein. One or more computer systems 1500 may perform at different times or at different locations, one or more steps of one or more methods described or illustrated herein, where appropriate.

In particular implementations, computer system 1500 includes a processor 1502, memory 1504, storage 1506, an input/output (I/O) interface 1508, a communication interface 1510, and a bus 1512. Although this disclosure describes and illustrates a particular computer system having a particular number of particular components in a particular arrangement, this disclosure contemplates any suitable computer system having any suitable number of any suitable components in any suitable arrangement.

In particular implementations, processor 1502 includes hardware for executing instructions, such as those making up a computer program. As an example, and not by way of limitation, to execute instructions, processor 1502 may retrieve (or fetch) the instructions from an internal register, an internal cache, memory 1504, or storage 1506; decode and execute them; and then write one or more results to an internal register, an internal cache, memory 1504, or storage 1506. In particular implementations, processor 1502 may include one or more internal caches for data, instructions, or addresses. This disclosure contemplates processor 1502 including any suitable number of any suitable internal caches, where appropriate. As an example, and not by way of limitation, processor 1502 may include one or more instruction caches, one or more data caches, and one or more translation lookaside buffers (TLBs). Instructions in the instruction caches may be copies of instructions in memory 1504 or storage 1506, and the instruction caches may speed up retrieval of those instructions by processor 1502. Data in the data caches may be copies of data in memory 1504 or storage 1506 for instructions executing at processor 1502 to operate on; the results of previous instructions executed at processor 1502 for access by subsequent instructions executing at processor 1502 or for writing to memory 1504 or storage 1506; or other suitable data. The data caches may speed up reading or writing operations by processor 1502. The TLBs may speed up virtual-address translation for processor 1502. In particular implementations, processor 1502 may include one or more internal registers for data, instructions, or addresses. This disclosure contemplates processor 1502 including any suitable number of any suitable internal registers, where appropriate. Where appropriate, processor 1502 may include one or more arithmetic logic units (ALUs); be a multi-core processor; or include one or more processors. Although this disclosure describes and illustrates a particular processor, this disclosure contemplates any suitable processor.

In particular implementations, memory 1504 includes main memory for storing instructions for processor 1502 to execute or data for processor 1502 to operate on. As an example, and not by way of limitation, computer system 1500 may load instructions from storage 1506 or another source (such as, for example, another computer system 1500) to memory 1504. Processor 1502 may then load the instructions from memory 1504 to an internal register or internal cache. To execute the instructions, processor 1502 may retrieve the instructions from the internal register or internal cache and decode them. During or after execution of the instructions, processor 1502 may write one or more results (which may be intermediate or final results) to the internal register or internal cache. Processor 1502 may then write one or more of those results to memory 1504. In particular implementations, processor 1502 executes instructions in one or more internal registers or internal caches or in memory 1504 (as opposed to storage 1506 or elsewhere) and operates on data in one or more internal registers or internal caches or in memory 1504 (as opposed to storage 1506 or elsewhere). One or more memory buses (which may include an address bus and a data bus) may couple processor 1502 to memory 1504. Bus 1512 may include one or more memory buses, as described below. In particular implementations, one or more memory management units (MMUs) reside between processor 1502 and memory 1504 and facilitate access to memory 1504 requested by processor 1502. In particular implementations, memory 1504 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1504 may include one or more memory units, where appropriate. Although this disclosure describes and illustrates particular memory, this disclosure contemplates any suitable memory.

In particular implementations, storage 1506 includes mass storage for data or instructions. As an example, and not by way of limitation, storage 1506 may include a hard disk drive (HDD), a floppy disk drive, flash memory, an optical disc, a magneto-optical disc, magnetic tape, or a Universal Serial Bus (USB) drive or a combination of two or more of these. Storage 1506 may include removable or non-removable (or fixed) media, where appropriate. Storage 1506 may be internal or external to computer system 1500, where appropriate. In particular implementations, storage 1506 is non-volatile, solid-state memory. In particular implementations, storage 1506 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1506 taking any suitable physical form. Storage 1506 may include one or more storage control units facilitating communication between processor 1502 and storage 1506, where appropriate. Where appropriate, storage 1506 may include one or more storages. Although this disclosure describes and illustrates particular storage, this disclosure contemplates any suitable storage.

In particular implementations, I/O interface 1508 includes hardware, software, or both, providing one or more interfaces for communication between computer system 1500 and one or more I/O devices. Computer system 1500 may include one or more of these I/O devices, where appropriate. One or more of these I/O devices may enable communication between a person and computer system 1500. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces for them. Where appropriate, I/O interface 1508 may include one or more devices or software drivers enabling processor 1502 to drive one or more of these I/O devices. I/O interface 1508 may include one or more I/O interfaces, where appropriate. Although this disclosure describes and illustrates a particular I/O interface, this disclosure contemplates any suitable I/O interface.

In particular implementations, communication interface 1510 includes hardware, software, or both, providing one or more interfaces for communication (such as, for example, packet-based communication) between computer system 1500 and one or more other computer systems or one or more networks. As an example, and not by way of limitation, communication interface 1510 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1510 for it. As an example, and not by way of limitation, computer system 1500 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1500 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1500 may include any suitable communication interface 1510 for any of these networks, where appropriate. Communication interface 1510 may include one or more communication interfaces, where appropriate. Although this disclosure describes and illustrates a particular communication interface, this disclosure contemplates any suitable communication interface.

In particular implementations, bus 1512 includes hardware, software, or both, coupling components of computer system 1500 to one another. As an example, and not by way of limitation, bus 1512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1512 may include one or more buses, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such as, for example, field-programmable gate arrays (FPGAs) or application-specific integrated circuits (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Example clauses associated with the present disclosure are below. The clauses described should not be considered exhaustive.

Clause 1. A computer-implemented method, comprising: identifying a preference associated with a prompt, wherein the preference is associated with a first feature and a second feature; determining, based on an input, a position within a range defined using the first feature and the second feature; providing the position within the range to a model to modify generation of a response to the prompt based on the position; receiving, from the model, the response to the prompt; and initiating display of the response.

Clause 2. The computer-implemented method of clause 1, wherein identifying the preference includes steps of: obtaining, from the model, candidate preferences associated with the prompt; presenting controls corresponding to the candidate preferences; and receiving a selection of a control corresponding to a candidate preference, wherein the selection identifies the candidate preference as the preference.

Clause 3. The computer-implemented method of clause 1, wherein the position is a strength of bias toward a feature selected from the first feature and the second feature.

Clause 4. The computer-implemented method of clause 3, further comprising: presenting, in response to identifying the preference, a user interface element corresponding to the range to receive the input of the strength of bias toward the feature, wherein the position is determined based on the input.

Clause 5. The computer-implemented method of clause 1, wherein identifying the preference includes steps of: obtaining, from the model, a first candidate response to the prompt and a second candidate response to the prompt, wherein the second candidate response is distinct from the first candidate response; presenting a first selectable component corresponding to the first candidate response, wherein selection of the first selectable component identifies the first candidate response as the preference; and presenting a second selectable component corresponding to the second candidate response, wherein selection of the second selectable component identifies the second candidate response as the preference.

Clause 6. The computer-implemented method of clause 5, wherein the position is a strength of bias between the first candidate response and the second candidate response.

Clause 7. The computer-implemented method of clause 6, wherein determining the position includes: presenting first options corresponding to the first candidate response and second options corresponding to the second candidate response, wherein a first option defines a first strength of bias toward the first candidate response, and a second option defines a second strength of bias toward the second candidate response; and receiving a selection of an option as the input from the first options or the second options, wherein the option in the input indicates a strength of bias from the first strength and the second strength, wherein the position within the range is determined based on the input.

Clause 8. The computer-implemented method of clause 1, wherein the input includes a sequence of interactions with respective responses obtained from the model, and the position is determined based on iteratively adjusting a prior position within the range based on the sequence of interactions.

Clause 9. A computing system comprising: at least one processor; and a memory communicably coupled to the at least one processor, the memory storing instructions that, when executed by the at least one processor, cause the computing system to: identify a preference associated with a prompt, wherein the preference is associated with a first feature and a second feature; determine, based on an input, a position within a range defined using the first feature and the second feature; provide the position within the range to a model to modify generation of a response to the prompt based on the position; receive, from the model, the response to the prompt; and initiate display of the response.

Clause 10. The computing system of clause 9, wherein the preference is identified by: obtaining, from the model, candidate preferences associated with the prompt; presenting controls corresponding to the candidate preferences; and receiving a selection of a control corresponding to a candidate preference, wherein the selection identifies the candidate preference as the preference.

Clause 11. The computing system of clause 9, wherein the position is a strength of bias toward a feature selected from the first feature and the second feature.

Clause 12. The computing system of clause 11, wherein the instructions cause the computing system to present, in response to identifying the preference, a user interface element corresponding to the range to receive the input of the strength of bias toward the feature, wherein the position is determined based on the input.

Clause 13. The computing system of clause 9, wherein the preference is identified by: obtaining, from the model, a first candidate response to the prompt and a second candidate response to the prompt, wherein the second candidate response is distinct from the first candidate response; presenting a first selectable component corresponding to the first candidate response, wherein selection of the first selectable component identifies the first candidate response as the preference; and presenting a second selectable component corresponding to the second candidate response, wherein selection of the second selectable component identifies the second candidate response as the preference.

Clause 14. The computing system of clause 13, wherein the position is a strength of bias between the first candidate response and the second candidate response.

Clause 15. The computing system of clause 14, wherein the position is determined by: presenting first options corresponding to the first candidate response and second options corresponding to the second candidate response, wherein a first option defines a first strength of bias toward the first candidate response, and a second option defines a second strength of bias toward the second candidate response; and receiving a selection of an option as the input from the first options or the second options, wherein the option in the input indicates a strength of bias from the first strength and the second strength, wherein the position within the range is determined based on the input.

Clause 16. The computing system of clause 9, wherein the input includes a sequence of interactions with respective responses obtained from the model, and the position is determined based on iteratively adjusting a prior position within the range based on the sequence of interactions.

Clause 17. A computer program product comprising a non-transitory storage medium, the computer program product includes instructions that, when executed by processing circuitry, cause the processing circuitry of a computing system to perform a method, the method comprising: identifying a preference associated with a prompt, wherein the preference is associated with a first feature and a second feature; determining, based on an input, a position within a range defined using the first feature and the second feature; providing the position within the range to a model to modify generation of a response to the prompt based on the position; receive from the model, the response to the prompt; and initiating display of the response.

Clause 18. The computer program product of clause 17, wherein the instructions, when executed by processing circuitry, cause the processing circuitry to identify the preference by: obtaining, from the model, candidate preferences associated with the prompt; presenting controls corresponding to the candidate preferences; and receiving a selection of a control corresponding to a candidate preference, wherein the selection identifies the candidate preference as the preference.

Clause 19. The computer program product of clause 17, wherein the instructions, when executed by processing circuitry, cause the processing circuitry to identify the preference by: obtaining, from the model, a first candidate response to the prompt and a second candidate response to the prompt, wherein the second candidate response is distinct from the first candidate response; and presenting a first selectable component corresponding to the first candidate response, wherein selection of the first selectable component identifies the first candidate response as the preference; and presenting a second selectable component corresponding to the second candidate response, wherein selection of the second selectable component identifies the second candidate response as the preference.

Clause 20. The computer program product of clause 17, wherein the position is a strength of bias toward a feature selected from the first feature and the second feature.

Specific structural and functional details disclosed herein are merely representative for purposes of describing example implementations. Example implementations, however, may be implemented in many alternate forms and should not be construed as limited to the implementations set forth herein.

The terminology used herein is for the purpose of describing particular implementations and is not intended to be limiting of the implementations. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of the stated features, steps, operations, elements, and/or components, but do not preclude the presence or addition of one or more other features, steps, operations, elements, components, and/or groups thereof.

It will be understood that when an element is referred to as being “coupled,” “connected,” or “responsive” to, or “on,” another element, it can be directly coupled, connected, or responsive to, or on, the other element, or intervening elements may also be present. In contrast, when an element is referred to as being “directly coupled,” “directly connected,” or “directly responsive” to, or “directly on,” another element, there are no intervening elements present. As used herein, the term “and/or” includes any and all combinations of one or more of the associated listed items.

Spatially relative terms, such as “beneath,” “below,” “lower,” “above,” “upper,” and the like, may be used herein for ease of description to describe one element or feature in relationship to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below”, or “beneath” other elements or features would then be oriented “above” the other elements or features. Thus, the term “below” can encompass both an orientation of above and below. The device may be otherwise oriented, and the spatially relative descriptors used herein may be interpreted accordingly.

Example implementations of the concepts are described herein with reference to cross-sectional illustrations that are schematic illustrations of idealized implementations (and intermediate structures) of example implementations. As such, variations from the shapes of the illustrations as a result, for example, of manufacturing techniques and/or tolerances, are to be expected. Thus, example implementations of the described concepts should not be construed as limited to the shapes of regions illustrated herein, but are to include deviations in shapes that result, for example, from manufacturing. Accordingly, the regions illustrated in the figures are schematic in nature, and their shapes are not intended to illustrate the actual shape of a region of a device, and are not intended to limit the scope of example implementations.

It will be understood that although the terms “first,” “second,” etc. may be used herein to describe various elements, these elements should not be limited by these terms. These terms are used to distinguish one element from another. Thus, a “first” element could be termed a “second” element without departing from the teachings of the present implementations.

Unless otherwise defined, the terms (including technical and scientific terms) used herein have the same meaning as commonly understood by one of ordinary skill in the art to which these concepts belong. It will be further understood that terms, such as those defined in commonly used dictionaries, should be interpreted as having a meaning that is consistent with their meaning in the context of the relevant art and/or the present specification, and will not be interpreted in an idealized or overly formal sense unless expressly so defined herein.

While some features of the described implementations have been illustrated as described herein, many modifications, substitutions, changes, and equivalents will now occur to those skilled in the art. It is, therefore, to be understood that the appended claims are intended to cover such modifications and changes as fall within the scope of the implementations. It should be understood that they have been presented by way of example, not limitation, and various changes in form and details may be made. Any portion of the apparatus and/or methods described herein may be combined in any combination. The implementations described herein can include various combinations and/or sub-combinations of the functions, components, and/or features of the different implementations described.

A number of implementations have been described. Nevertheless, it will be understood that various modifications may be made without departing from the spirit and scope of the specification. Logic flows depicted herein do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A computer-implemented method, comprising:
identifying a preference associated with a prompt, wherein the preference is associated with a first feature and a second feature;
determining, based on an input, a position within a range defined using the first feature and the second feature;
providing the position within the range to a model to modify generation of a response to the prompt based on the position;
receiving, from the model, the response to the prompt; and
initiating display of the response.

2. The computer-implemented method of claim 1, wherein identifying the preference includes steps of:
obtaining, from the model, candidate preferences associated with the prompt;
presenting controls corresponding to the candidate preferences; and
receiving a selection of a control corresponding to a candidate preference, wherein the selection identifies the candidate preference as the preference.

3. The computer-implemented method of claim 1, wherein the position is a strength of bias toward a feature selected from the first feature and the second feature.

4. The computer-implemented method of claim 3, further comprising:
presenting, in response to identifying the preference, a user interface element corresponding to the range to receive the input of the strength of bias toward the feature, wherein the position is determined based on the input.

5. The computer-implemented method of claim 1, wherein identifying the preference includes steps of:
obtaining, from the model, a first candidate response to the prompt and a second candidate response to the prompt, wherein the second candidate response is distinct from the first candidate response;
presenting a first selectable component corresponding to the first candidate response, wherein selection of the first selectable component identifies the first candidate response as the preference; and
presenting a second selectable component corresponding to the second candidate response, wherein selection of the second selectable component identifies the second candidate response as the preference.

6. The computer-implemented method of claim 5, wherein the position is a strength of bias between the first candidate response and the second candidate response.

7. The computer-implemented method of claim 6, wherein determining the position includes:
presenting first options corresponding to the first candidate response and second options corresponding to the second candidate response, wherein a first option defines a first strength of bias toward the first candidate response, and a second option defines a second strength of bias toward the second candidate response; and
receiving a selection of an option as the input from the first options or the second options, wherein the option in the input indicates a strength of bias from the first strength and the second strength,
wherein the position within the range is determined based on the input.

8. The computer-implemented method of claim 1, wherein the input includes a sequence of interactions with respective responses obtained from the model, and the position is determined based on iteratively adjusting a prior position within the range based on the sequence of interactions.

9. A computing system comprising:
at least one processor; and
a memory communicably coupled to the at least one processor, the memory storing instructions that, when executed by the at least one processor, cause the computing system to:
identify a preference associated with a prompt, wherein the preference is associated with a first feature and a second feature;
determine, based on an input, a position within a range defined using the first feature and the second feature;
provide the position within the range to a model to modify generation of a response to the prompt based on the position;
receive, from the model, the response to the prompt; and
initiate display of the response.

10. The computing system of claim 9, wherein the preference is identified by:
obtaining, from the model, candidate preferences associated with the prompt;
presenting controls corresponding to the candidate preferences; and
receiving a selection of a control corresponding to a candidate preference, wherein the selection identifies the candidate preference as the preference.

11. The computing system of claim 9, wherein the position is a strength of bias toward a feature selected from the first feature and the second feature.

12. The computing system of claim 11, wherein the instructions cause the computing system to present, in response to identifying the preference, a user interface element corresponding to the range to receive the input of the strength of bias toward the feature, wherein the position is determined based on the input.

13. The computing system of claim 9, wherein the preference is identified by:
obtaining, from the model, a first candidate response to the prompt and a second candidate response to the prompt, wherein the second candidate response is distinct from the first candidate response;
presenting a first selectable component corresponding to the first candidate response, wherein selection of the first selectable component identifies the first candidate response as the preference; and
presenting a second selectable component corresponding to the second candidate response, wherein selection of the second selectable component identifies the second candidate response as the preference.

14. The computing system of claim 13, wherein the position is a strength of bias between the first candidate response and the second candidate response.

15. The computing system of claim 14, wherein the position is determined by:
presenting first options corresponding to the first candidate response and second options corresponding to the second candidate response, wherein a first option defines a first strength of bias toward the first candidate response, and a second option defines a second strength of bias toward the second candidate response; and
receiving a selection of an option as the input from the first options or the second options, wherein the option in the input indicates a strength of bias from the first strength and the second strength,
wherein the position within the range is determined based on the input.

16. The computing system of claim 9, wherein the input includes a sequence of interactions with respective responses obtained from the model, and the position is determined based on iteratively adjusting a prior position within the range based on the sequence of interactions.

17. A computer program product comprising a non-transitory storage medium, the computer program product includes instructions that, when executed by processing circuitry, cause the processing circuitry of a computing system to perform a method, the method comprising:
identifying a preference associated with a prompt, wherein the preference is associated with a first feature and a second feature;
determining, based on an input, a position within a range defined using the first feature and the second feature;
providing the position within the range to a model to modify generation of a response to the prompt based on the position;
receive from the model, the response to the prompt; and
initiating display of the response.

18. The computer program product of claim 17, wherein the instructions, when executed by processing circuitry, cause the processing circuitry to identify the preference by:
obtaining, from the model, candidate preferences associated with the prompt;
presenting controls corresponding to the candidate preferences; and
receiving a selection of a control corresponding to a candidate preference, wherein the selection identifies the candidate preference as the preference.

19. The computer program product of claim 17, wherein the instructions, when executed by processing circuitry, cause the processing circuitry to identify the preference by:
obtaining, from the model, a first candidate response to the prompt and a second candidate response to the prompt, wherein the second candidate response is distinct from the first candidate response; and
presenting a first selectable component corresponding to the first candidate response, wherein selection of the first selectable component identifies the first candidate response as the preference; and
presenting a second selectable component corresponding to the second candidate response, wherein selection of the second selectable component identifies the second candidate response as the preference.

20. The computer program product of claim 17, wherein the position is a strength of bias toward a feature selected from the first feature and the second feature.
